(19) United States
(12) Patent Application Publication
(10) Pub. No.: US 2014/0044632 A1
(43) Pub. Date: Feb. 13, 2014

(54) METHOD AND APPARATUS FOR REMOVAL OF CARBON DIOXIDE FROM AUTOMOBILE, HOUSEHOLD AND INDUSTRIAL EXHAUST GASES

(71) Applicants: Marek Zielinski, Rego Park, NY (US); Henry Wala, Greenwich, CT (US); Dariuz Szerejko, Ryebrook, NY (US); Donald G. Rynne, Greenwich, CT (US)

(72) Inventors: Marek Zielinski, Rego Park, NY (US); Henry Wala, Greenwich, CT (US); Dariuz Szerejko, Ryebrook, NY (US); Donald G. Rynne, Greenwich, CT (US)

(73) Assignee: RYNCOSMOS LLC, Greenwich, CT (US)

(21) Appl. No.: 14/112,529

(22) PCT Filed: Apr. 17, 2012
(86) PCT No.: PCT/US2012/033917

§ 371 Date: Oct. 17, 2013

Related U.S. Application Data
(60) Provisional application No. 61/476,651, filed on Apr. 18, 2011.
(60) Provisional application No. 61/554,036, filed on Nov. 1, 2011.

(51) Int. Cl. B01D 53/62; B60K 13/04; C01B 31/20; F01N 3/28; B01D 53/92; C01B 31/24

(52) U.S. Cl. CPC B01D 53/62; B01D 53/92; C01B 31/24; C01B 31/20; F01N 3/28; B60K 13/04
USPC 423/230; 60/320; 60/274; 423/419.1; 423/438; 422/180; 422/111; 422/176; 422/122; 180/309

(57) ABSTRACT

An exhaust processing assembly for an exhaust generating device, the exhaust processing assembly comprising one or more cartridges, each of the cartridges including a housing and a constituent housed in the housing and capable of at least partially removing carbon dioxide from the exhaust of the exhaust generating device, said constituent being one or more of a solid absorber and any other constituent, wherein the cartridges are one of: removable from the exhaust processing assembly and replaceable with other like cartridges, and refillable with new constituent.

### FIELD OF THE INVENTION

The present invention relates to a carbon dioxide (CO₂) removal method and apparatus, and in particular to a method and apparatus for removing carbon dioxide from exhaust gases output from automobiles, trucks, busses and the like, and output during household heating and industrial processes.

### BACKGROUND OF THE INVENTION

Greenhouse gas emissions, and in particular emissions of carbon dioxide into the atmosphere, have long presented serious environmental concerns and increased emissions of greenhouse gases have been tied to climate change and global warming effects. According to the Environmental Protection Agency (EPA), “greenhouse gases in the atmosphere endanger public health and welfare of current and future generations” and increased greenhouse gases in the atmosphere are attributable to human activity. EPA's Endangerment Finding (2009). For example, the average atmospheric concentrations of carbon dioxide globally have increased about 38% from pre-industrial levels to 2009, almost all of which are due to human activities, and under all scenarios, projected carbon dioxide concentrations will increase by 2030 as compared to 2000. Numerous sources of evidence show that increased greenhouse emissions from human activities have contributed to global warming and climate changes, including increased global average air and ocean temperatures, increased widespread melting of snow and ice in the Arctic, melting glaciers around the world, rising average sea levels, acidification of oceans due to excess carbon dioxide, changing precipitation patterns and changing patterns of ecosystem and wildlife functions. Multiple studies have shown a global warming trend over the past 100 years, with the greatest increase being in the recent decades. In addition, projected global warming in the 21^{st} century is likely to be larger than during the 20^{th} century and expected to be between 3 and 7 degrees Fahrenheit by the end of the 21^{st} century.

The major human activity contributing to the greenhouse gas emissions is fossil fuel combustion, which is attributed to several categories of end-users. The main end-user categories that use or rely on fossil fuel combustion include industrial, transportation, residential and commercial sectors. In the U.S., transportation and industrial sectors have been the greatest contributors to greenhouse emissions into the atmosphere, with carbon dioxide being the highest of the greenhouses gases emitted. For example, between the years 2000 and 2009, the transportation sector in the U.S. accounted for 1723-1901 Teragrams (Tg) of carbon dioxide emissions per year, while the industrial sector in the U.S. accounted for 1341.7-1644 Tg of carbon dioxide emissions for year. In the transportation sector, the most common types of fuel used are diesel, biofuel and gasoline, which produce 9.96 kg, 9.42 kg and 8.71 kg of carbon dioxide per gallon, respectively. When an average distance traveled and average fuel efficiency for passenger cars and light trucks are taken into account, it is estimated that an average vehicle produces about 5.2 metric tons of carbon dioxide per year. EPA: Office of Transportation and Air Quality, Emission Facts: Greenhouse gas emissions from a typical passenger vehicle (February 2005).

There have been several proposed responses to global warming and climate changes, which include reduction in the greenhouse gas emissions and geoengineering strategies to remove greenhouse gases from the atmosphere. The Kyoto Protocol, which was adopted in 1997 and entered into in 2005, and which has been ratified by 193 countries, is directed to stabilizing greenhouse gas concentrations and reducing greenhouse gas emissions into the atmosphere. Although a reduction in the atmospheric carbon dioxide emissions is highly desired and needed in order to slow down global warming, it has proven to be a challenging task, particularly in the transportation sector.

The main challenges for reducing carbon dioxide emissions from the industrial and/or transportation sectors are concerned with how to capture the carbon dioxide before it is emitted into the atmosphere and how to remove and/or subsequently utilize the captured carbon dioxide. In the transportation sector, these challenges are particularly difficult to overcome due to the considerable weight and volume of carbon dioxide produced by each vehicle and the limited amount of space within each vehicle. In fact, experts in the area of carbon dioxide removal have recognized that use of scrubbers, such as absorbers, are impractical in cars and that scrubber systems are difficult to retrofit in power plants. See, Andrea Thompson, New Device Vacuums Away Carbon Dioxide, LiveScience.com (Jan. 11, 2008). As a result, though there have been various attempts at capturing carbon dioxide by the various sectors, including the transportation sector, there have not been any successful systems to date that are capable of effectively capturing and removing carbon dioxide from vehicle exhaust, without impeding the vehicle's operation and without sacrificing the space inside the vehicle. In addition, there have not been any carbon dioxide capturing and/or removal systems to date that are cost effective and provide sufficient incentives for the transportation industry to include such systems in their vehicles.

### SUMMARY OF THE INVENTION

The object of the present invention is to provide a system and a method for capturing carbon dioxide from gas exhaust, which can be effectively adapted for use in a variety of vehicles of the transportation sector and which can also be adapted for household use and for use by the industrial sector. It is a further object of this invention to provide a system, and a method, in which removal of captured carbon dioxide is simple and can be easily accomplished by users of a variety of vehicle types and in household use, particularly in household heating and water heating systems. It is yet another object of this invention to provide a system and method for reducing atmospheric carbon dioxide which provide additional incentives for the transportation industry, for the household heating industry, as well as for the industrial sector, to use such system and method.

The technology developed by applicants and described herein addresses the issue of greenhouse emission reduction by removing carbon dioxide from exhaust, such as automobile exhaust or heating systems exhaust. As discussed above, most of the car and truck fleets are using carbon based fuels, and burning of diesel, biodiesel or gasoline releases significant amounts of carbon dioxide to the atmosphere (ca. 19 to 22 pounds of CO₂ per gallon of fuel). Similarly, household heating systems use carbon based fuels, and as a result, also release significant amounts of carbon dioxide to the atmosphere. Applicants' system and method provide for capturing of a significant portion of the carbon dioxide produced in the car or truck engine or in a household heating system, and allow for safe disposal and/or recycling of the resulting solid material. The system and method of capturing the carbon dioxide uses an absorber which is based on a combination of alkali and alkaline earth metal hydroxides. Both the absorber and the absorption byproducts are preferably in form of granules that can be handled easily.

The system of applicants' invention may be fitted in automobiles and trucks, and will not adversely affect the flow of exhaust gases nor the efficiency of the engine. Moreover, the system of the present invention may be retrofitted in existing trucks, or may be included in new trucks and cars. Likewise, the system may be fitted in existing household heating and water heating systems and in certain embodiments, increase the efficiency of such systems. In order to facilitate handling of the absorber and/or absorption byproducts, the system includes cartridges or compartments which house the absorber therein. The cartridges or compartments are removable and replaceable after the absorber is spent, so that new, replacement, cartridges or compartments with a fresh absorber may be installed.

The system of the present invention includes a plurality of cartridges wherein at least some of the cartridges are connected to the exhaust system of the vehicle or the heating system in parallel and the flow of the exhaust gas output by the vehicle or heating system through one or more cartridges is controlled using a valve assembly, so that the exhaust gas output by the vehicle or heating system is passed through one or more active cartridges while the other cartridges are in standby mode. In some embodiments, groups of two or more cartridges may be connected in parallel to the exhaust system, with the cartridges in each group being connected in series or in parallel, so that the exhaust gas output by the vehicle or the heating system is conveyed through the cartridges of one group, while the other groups of cartridges are in standby mode.

In certain embodiments, the system is equipped with an electronically activated valve assembly and carbon dioxide sensors, controlled by an on-board computer of the vehicle or by a controller or computer for controlling the heating system. The carbon dioxide sensors sense the concentration of carbon dioxide in the exhaust prior to, and after, being conveyed through one or more cartridges or through one or more groups of cartridges, and the computer monitors the state of the carbon dioxide absorption by the active cartridges based on the sensor readings. Based on the state of carbon dioxide absorption, the computer determines when switching from the active cartridges or active group of cartridges to one or more standby cartridges or groups of cartridges should be made and controls the valve assembly accordingly. In a vehicle, the computer may also combine the carbon dioxide absorption information with other data collected by on-board sensors of the vehicle in making the switching determination and controlling the valve assembly. In a household heating system, the computer or controller may also collect data and monitor the status of the heating system using other sensors of the heating system and use such data in making the switching determination and controlling the valve assembly. The control by the computer eliminates the need for the driver or user to manually check the status of the system, and also facilitates the reporting of the emission reduction. In such embodiments, the computer alerts the user when the switching between active cartridges is made and which absorber cartridges require replacement. In larger systems, the computer will also automatically switch absorber cartridge banks to facilitate the replacement.

In using the present invention, the replacement of cartridges used in vehicles may be done at truck stops and/or gas stations, where new absorber cartridges may also be obtained and which handle the recycling or disposal of spent material. The process of replacing the used-up cartridges includes removing one or more of individual cartridges and replacing them with new ones. Alternatively, fluidized bed technology may be used to transport the spent material from the cartridges or containers and to refill the containers with new absorber.

The system of the present invention is capable of absorbing up to 100% CO₂ in the exhaust gasses, and the absorption coefficient depends on the absorber bed cross section, carbon dioxide concentration, granule size and gas flow. In certain embodiments, in order to facilitate useability of the system and to reduce the burden on the user, the system has an overall average reduction of 25% to 50% of carbon dioxide.

A business system and a method for removal of carbon dioxide from exhaust of a carbon dioxide generation device is also disclosed. In certain embodiments, the entities involved in the business system and method include one or more of the following: carbon dioxide or exhaust generation devices, cartridge replacement stations, cartridge replacement service providers, cartridge regeneration providers, carbon dioxide users or consumers, spent cartridge consumers or users, one or more emissions agencies and carbon credit buyers. The business system and method are configured to provide incentives and/or carbon credits to one or more of users of carbon dioxide generation devices, cartridge replacement stations, cartridge replacement service providers and cartridge regeneration providers.

As described above, the carbon dioxide removal system of the present invention is also adapted for industrial use, household use and other uses, which are described herein. In particular, household uses of the carbon dioxide removal system with household heating systems as carbon dioxide generation devices are disclosed. In certain embodiments, the carbon dioxide removal system further includes a heating system which heats water or another fluid using the exhaust of the carbon dioxide generation device in order to provide added efficiencies and to reduce overall fuel consumption. Use of household carbon dioxide removal systems in the business system and method for removal of carbon dioxide from exhaust of household heating carbon dioxide generation devices is also disclosed.

### BRIEF DESCRIPTION OF DRAWINGS

FIG. 1 is a general view of a carbon dioxide removal system of the present invention;

FIG. 2 is a schematically shows the carbon dioxide removal system of FIG. 1 adapted for use in a vehicle;

FIGS. 3A-C show 3-dimensional perspective, front and side views of the carbon dioxide removal system of FIG. 1 adapted for use in a vehicle;

FIG. 4 outlines a carbon dioxide removal and capture method using the system of FIG. 1;

FIG. 5 shows a business system for removing carbon dioxide from exhaust using the system of FIG. 1 and providing replacement cartridges for the system of FIG. 1;

FIG. 6 shows another embodiment of the business system of FIG. 5;

FIG. 7 shows test results for a prototype system used in a vehicle;

FIG. 8 schematically shows the carbon dioxide removal system of FIG. 1 adapted for household use;

FIG. 9 shows another embodiment of the carbon dioxide removal system of FIG. 8;

FIG. 10 shows a modified embodiment of the carbon dioxide removal system of FIG. 8; and

FIGS. 11A-11C show exemplary arrangements of the carbon dioxide removal system of FIG. 10.

### DETAILED DESCRIPTION

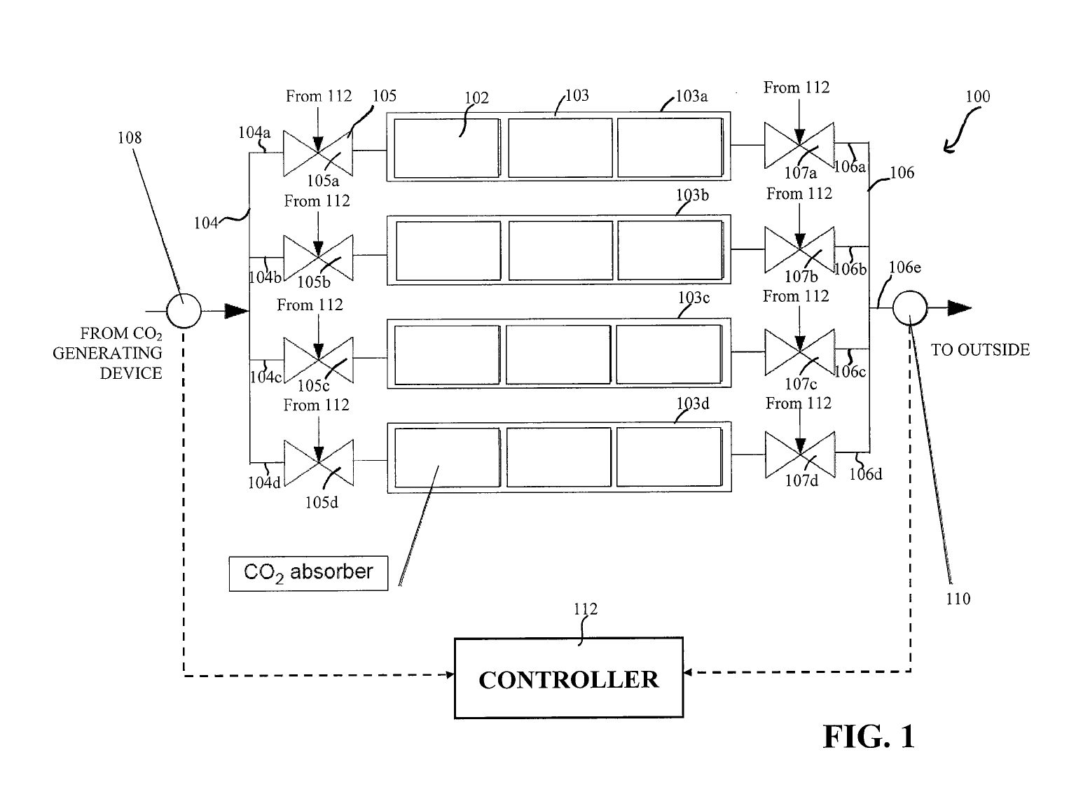

FIG. 1 shows a general view of the carbon dioxide removal system 100 of the present invention. As shown, the system includes one or more absorption cartridges or containers 102 that house therein absorbent material for absorbing carbon dioxide, an input connection assembly 104 that connects an exhaust assembly of an exhaust generating system with the cartridges 102 of the system 100, and an output connection assembly 106 which connects the cartridges 102 with the outside for outputting processed exhaust gas to the outside. In the embodiment shown, the cartridges 102 are removably disposed in predetermined chambers 103 so that cartridges with spent absorbent may be removed from their respective chambers and replaced with new cartridges. As also shown, each chamber 103 may be adapted to house a plurality of cartridges 102, e.g. 3 cartridges in each chamber. The input connection assembly 104 includes one or more valves 105 for controlling the flow of exhaust gas through one or more chambers 103 or cartridges 102, while the output connection assembly 106 includes a plurality of valves 107 for controlling the flow of processed exhaust gas from the cartridges 102 to the outside.

As also shown in FIG. 1, the system 100 includes one or more detectors 108, 110 for detecting the concentration of carbon dioxide in the exhaust gas. In particular, the system 100 includes at least one detector 108 for detecting the concentration of carbon dioxide in the exhaust gas prior to being conveyed through one or more cartridges 102 and another detector 110 for detecting the concentration of carbon dioxide in the processed exhaust gas after being conveyed through one or more cartridges. The detectors 108, 110 provide output signals that include carbon dioxide concentration readings to a controller 112, which uses the signals received from the detectors 108, 110 to monitor the status and operation of the cartridges 102 in the system and to control the valves 105, 107 so as to direct and/or re-direct the exhaust gas through selected cartridges. Moreover, the controller 112 uses the signals received from the detectors 108, 110 to determine which cartridges have been used up and need replacement and the timing for the replacement, and to output a signal to a user or operator of the exhaust generating system indicating the need for such replacement. In addition, or alternatively to receiving the signals from the detectors 108, 110, the controller 112 monitors the approximate amount of fuel used and determines, based on the amount of fuel used, when the cartridge(s) need replacement. The controller 112 may be part of the computer controlling the exhaust generating system or may be a separate controller adapted specifically for controlling the carbon dioxide removal system.

As shown in FIG. 1, the input and output connection assemblies 104, 106 connect the chambers 103 with the exhaust assembly of the exhaust generating device in parallel, and the valves 105, 107 are used for controlling the flow of exhaust gas through each of the chambers 103. As mentioned herein above, each chamber 103 may house one or more cartridges 102 with the absorber material. In the embodiment shown in FIG. 1, each chamber 103 houses three cartridges 102, which are connected in series with one another so that the exhaust gas flows through a first cartridge, thereafter through a second cartridge and then through a third cartridge. However, the number of cartridges 102 housed in each chamber may be varied depending on system's requirements and the type of exhaust generation device with which the system is used.

Also, in the embodiment shown in FIG. 1, the system includes a plurality of chambers 103a-103d, e.g. four chambers, which are connected with the exhaust generating device by connecting lines 104a-104d of the input connection assembly and with an output line 106e of the output connection assembly 106 by connecting lines 106a-106d. As shown, the flow of exhaust gas through one or more of the connecting lines 104a-104d is controlled by corresponding valves 105a-105d in the connecting lines, and the valves 105a-105d are in turn controlled by the controller 112. It is understood that the number of chambers 103 and the corresponding number of connecting lines 104, 106 and valves 105 may be varied depending on the system's requirements and the type of exhaust generation device with which the system is used. Moreover, some systems may use only one chamber 103, or in alternative embodiments, the cartridges may be connected directly with the input and output connection assemblies 104, 106 without using a chamber to house them.

In constructing the specific system with one or more chambers or cartridges and input and output connection assemblies, care must be taken to consider possible pressure losses through valves, fittings and pipes which form the input and output connection assemblies and to design the system so that the flow of exhaust is distributed evenly, particularly when the exhaust flows through several cartridges in parallel. In particular, the gas flow through the system depends on the physical arrangement of the absorber cartridges and the connection assemblies 104, 106. For example, when the system 100 is used in a vehicle, the pressure drop through the cartridges is relatively small and is dependent on the RPM of the vehicle's engine, and thus, the flow through the connection assemblies 104, 106 must be considered when determining the physical arrangement of the system components.

In a system 100 which includes two or more cartridges disposed in parallel and with the exhaust gas being supplied simultaneously to two or more cartridges disposed in parallel, the input connection assembly 104 is arranged so that the exhaust gas flow to each of the two or more cartridges is substantially equal in order to make sure that the absorbers of the two or more cartridges are being used up evenly. For example, such even flow distribution among two or more cartridges may be accomplished using a Y connector or similar pipe to split the flow of the gas into two symmetrical connecting lines. Such arrangement assures that the resistance is about the same in each of the two or more cartridges, and thus the flow of the gas through each of the cartridges is about the same.

In a system which includes two or more cartridges coupled to a single main connecting line, with a first cartridge being closer to the input of the exhaust than the other cartridge(s), the branching of the gas flow from the main connecting line to the first cartridge causes a reduction in pressure in the remaining portion of the main connecting line, and thus, a reduction in the gas flow to the other cartridge(s). In order to counteract this pressure reduction and to provide even gas flow to each of the cartridges, one or more baffles or constrictions are provided in a connecting line coupling the first cartridge with the main connecting line. In this way, the baffling or construction in the connecting line increases the gas velocity and decreases the pressure of the gas at a point where the exhaust gas enters into the first container. It is understood that the shape, number and positions of the baffle(s) and/or construction(s) may vary depending on the arrangement of the cartridges relative to the main connecting line, as long as the exhaust gas is controlled to be about equal to each of the cartridges.

During operation of the system 100, the controller 112 initially controls the valves 105a-d and 107a-d so that the exhaust gas output by the exhaust generating system is conveyed to one or more active chambers, or active cartridges, while the remaining chambers, or cartridges, are in standby mode and monitors the status of the active chambers, or cartridges, based on the received signals from the detectors 108, 110. For example, in the embodiment shown in FIG. 1, the controller 112 may initially control the valves 105a and 107a to open so as to convey the exhaust gas through the first chamber 103a, and may control the valves 105b-d and 107b-d to close so that the chambers 103b-d are in standby mode. Also, during operation, the controller 112 determines, based on the signals received from the detectors 108, 110 and/or based on the amount of fuel used by the system, whether the absorption capacity of the active cartridges in the active chamber(s) is below a predetermined level or has been used up and whether the active cartridges need to be replaced. In certain embodiments, the controller 112 also calculates how much of the absorber in the active cartridge has been used up, and based on this calculation, the controller determines whether the active cartridges need to be replaced. When the controller 112 determines that the active cartridges have been used up, or that the absorption capacity of the active cartridges is below the predetermined level, the controller controls the valves 105a-d, 107a-d to block the conveying of exhaust gas through the active chambers, or cartridges, and to redirect the flow of exhaust gas through one or more chambers, or cartridges, previously in standby mode. The controller 112 also outputs a signal to the user or operator of the exhaust generating system that the previously active cartridges need to be replaced or regenerated. For example, when the first chamber 103a is active and the chambers 103b-d are in standby, and the controller 112 determines that the absorption capacity of the cartridges in the first chamber 103a is below the predetermined level, the controller then controls the valves 105a, 107a to close so as to block the flow of exhaust through the first chamber 103a, and controls the valves 105b, 107b to open so as to convey the exhaust gas through the second chamber 103b. In addition, the controller 112 outputs a signal to the user or operator of the exhaust generating device that the cartridges in the first chamber 103a need to be replaced or regenerated.

As discussed hereinabove, each cartridge 102 houses an absorber for absorbing carbon dioxide. In the present invention, the absorber comprises one or more alkali hydroxides and/or alkali earth hydroxides, including, but not limited to, calcium hydroxide, sodium hydroxide and potassium hydroxide. In the illustrative embodiment of the present invention, the absorber comprises lime, and specifically, soda lime. The main component of soda lime is calcium hydroxide (Ca(OH)₂), with smaller amounts of sodium hydroxide (NaOH) and potassium hydroxide (KOH). The average composition of the soda lime absorbent is about 80% calcium hydroxide, about 3% sodium hydroxide and about 3% potassium hydroxide. When the exhaust containing carbon dioxide is conveyed through the soda lime absorber, calcium hydroxide in the soda lime reacts with the carbon dioxide to produce calcium carbonate, which is catalyzed by a strong base such as sodium hydroxide and/or potassium hydroxide in the soda lime. The overall reaction between the calcium hydroxide and carbon dioxide is as follows:

Ca(OH)₂+CO₂→CaCO₃+H₂O (Equation 1)

The above reaction occurs in a 3-step reaction, as follows:

1. CO₂+H₂O→CO₂(aq) (Equation 2)

2. CO₂(aq)+NaOH→NaHCO₃ (Equation 3)

3. NaHCO₃+Ca(OH)₂→CaCO₃+H₂O+NaOH (Equation 4)

By this reaction, 1 kg of Ca(OH)₂ reacts with about 0.59 kg of CO₂ to produce 1.35 kg of dry CaCO₃.

In the final stages of absorption, sodium and/or potassium hydroxides also react with the carbon dioxide to form sodium and/or potassium carbonates, by the following reactions:

2NaOH+CO₂→Na₂CO₃+H₂O (Equation 5)

2KOH+CO2→K₂CO₃+H₂O (Equation 6)

In these reactions 1 kg of NaOH reacts with about 0.55 kg of CO₂ to produce about 1.34 kg of dry Na₂CO₃, and 1 kg of KOH reacts with about 0.39 kg of CO₂ to produce about 1.23 kg of dry K₂CO₃. Overall, when soda lime absorber is used, 1 kg of soda lime reacts with about 0.5 kg of carbon dioxide yielding about 1.3 kg of dry end-product. However, due to the water content in the end product, the actual weight of the end product is higher. When 1 gallon of diesel fuel is burned, 9.96 kg of CO₂ is produced, which is absorbed by about 19.9 kg of soda lime absorber. The kinetics of the above reaction between the hydroxide absorbent and the carbon dioxide are controlled by the speed of the reaction, the diffusion of CO₂ in the exhaust gas flowing past the absorber and the diffusion of CO₂ through a layer of reaction product, i.e. CaCO₃, deposited on the absorber after a certain operating time period. The speed of carbon dioxide decreases non-linearly with time due to build-up of calcium carbonate on the absorbent. The spent absorber is essentially calcium carbonate or limestone and can be safely handled or stored in open spaces. Calcium carbonate may also be used as a raw material for production of calcium oxide (quicklime) and calcium hydroxide (slaked lime) and/or can be recycled into the absorber at appropriate regeneration plants. If calcium carbonate is recycled back into the soda lime absorber, carbon dioxide of high purity is released and can be sequestered without the need of expensive separation techniques. As discussed in more detail below, the released carbon dioxide may then be provided for a variety of uses, such as for use in algae farms or the like, for use in food, oil and chemical industry, for use in fire extinguishers and refrigeration, and other suitable uses. Also, as discussed below, the spent absorber may be used directly, without regenerating the absorber, for a variety of applications, including, but not limited to, in cement and concrete production, in blast furnaces, as a reagent in flue gas desulfurization, in glass making, as an acid neutralizer, as a filler or as a filter, and in many other industrial, chemical, agricultural and construction applications.

Soda lime absorber is widely available commercially and is an inexpensive material, which makes it a desirable absorber. Testing of carbon dioxide absorption with soda lime showed that the soda lime absorber is capable of absorbing close to 100% of carbon dioxide from the exhaust gas. The absorption rate, however, is dependent on the gas flow, including the time of contact of the exhaust gas with the absorber, and on the diffusion of the gas through the absorber.

In the illustrative embodiments described herein, calcium hydroxide is the preferred material for the absorber because of its low production cost and the general abundance of limestone which is the raw material for the production of calcium hydroxide. This absorber material may be modified with additives such as sodium hydroxides, potassium hydroxides and magnesium hydroxides to control the speed of the reaction with the carbon dioxide. Other additives can be used to facilitate forming the granules of the absorber in the requisite size and size distribution. Soda lime, described above, is an example of a calcium hydroxide absorber with sodium hydroxide and potassium hydroxide additives. Although calcium hydroxide, and in particular, soda lime are suitable absorbents for use in the present system, it is understood that other absorbents capable of absorbing carbon dioxide from exhaust gas may be used in the cartridges.

In the present invention, the absorber is in solid form and preferably in granular form, with some allowable variations in the average granule size. Through extensive experimentation, applicants determined that closely packed fine powder absorbent is less desirable, particularly in systems used for processing vehicle exhaust, because fine powder may clog the system, cause air pollution and increase the back pressure of the exhaust gas as it is output from the exhaust generating system. Therefore, granular form of the absorber is more preferable in the present system because granules offer less resistance to the exhaust gas flow and do not cause a significant increase in the back pressure of the exhaust gas. Although larger granules of the absorber provide less resistance to the flow of exhaust gas than smaller granules, the smaller granules offer faster absorption of carbon dioxide. In the present illustrative system, the granules of the absorber are preferably between 3 and 4 mm diameter so as to provide sufficiently quick rate of absorption of carbon dioxide while avoiding a significant increase in the back pressure of exhaust gas. For example, Medisorb® manufactured by GE Healthcare, Sodasorb® manufactured by Grace Group, Sofnolime® manufactured by Molecular Products, Inc., Agrisorb® manufactured by Akron Care or Sodalime manufactured by Jorgensen Laboratories, Inc., are suitable absorbers for use in the present invention.

In the embodiment shown in FIG. 1 and described above, removable and replaceable cartridges are used in the system 100. In other embodiments, the system may use cartridges, which may or may not be removable, that store absorbent therein which can be accessed by an operator or a user. In this way, instead of removing and replacing the entire cartridge, the operator or user can access the absorber in the cartridge so as to remove spent absorber and replace it with new absorber. In such embodiments, compressed air and fluidized flow of the absorber granules may be used for removing and replacing spent absorber. This removal and replacement may be automated for easy use of the system.

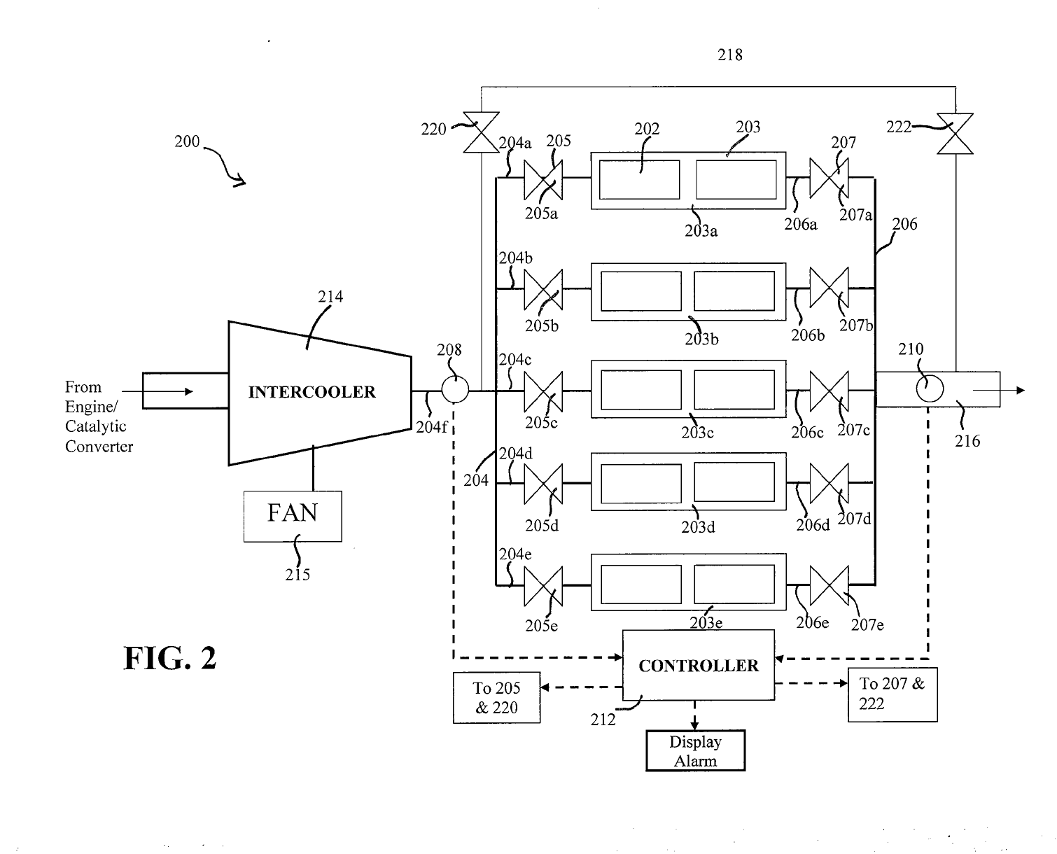

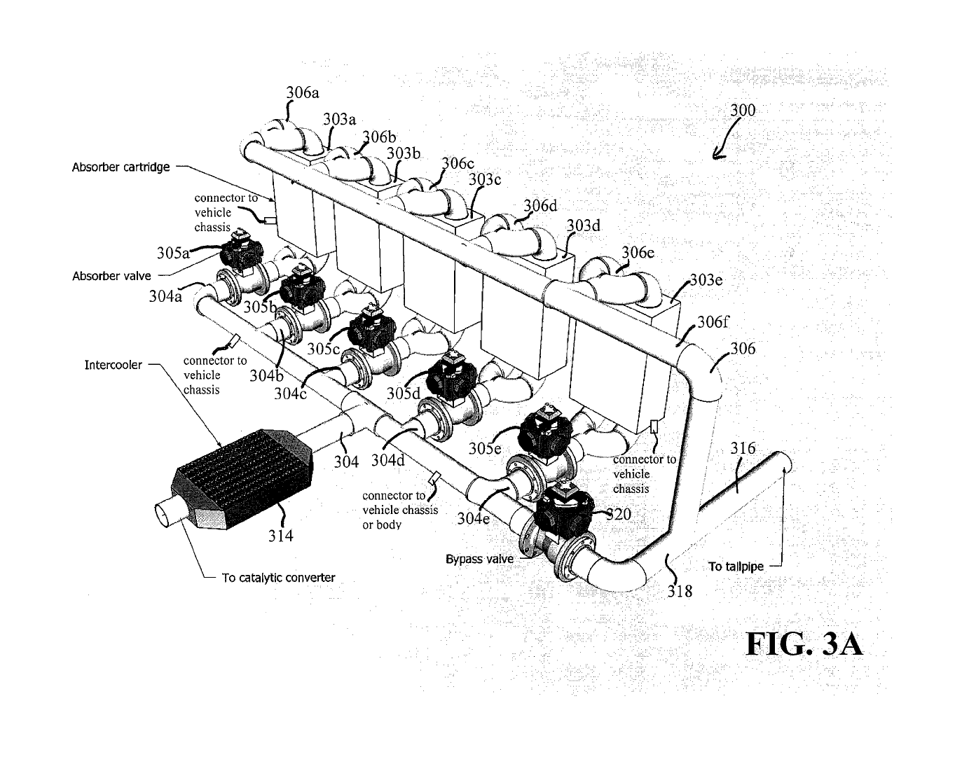

The above-described carbon dioxide removal system may be adapted for use in the transportation sector and in particular, for use in cars, trucks, busses and other vehicles. FIG. 2 shows the system 200 of FIG. 1 adapted for use in a vehicle. The system 200 of FIG. 2 may be installed in a new vehicle or may be retrofitted on an existing vehicle. Most of the system components in FIG. 2 are the same or similar to those of the system 100 of FIG. 1, and thus, similar reference numbers designate similar components.

As shown in FIG. 2, the system 200 includes one or more removable and replaceable absorber cartridges 202, which in the present embodiment are housed in one or more chambers 203. Each of the absorber cartridges 202 houses carbon dioxide absorber, as described above, which absorbs carbon dioxide by reacting with the carbon dioxide. In this illustrative embodiment, each chamber 203 includes two removable cartridges 202 connected in series with one another. However, it is understood that the number of removable cartridges housed by each chamber is merely illustrative and that the number of removable cartridges will be dependent on the type of vehicle and the size of the vehicle. Moreover, in some embodiments, the chambers 203 may be omitted and the cartridges 202 may be connected without being housed by a chamber 203.

In the embodiment shown, the chambers 203 are connected with the exhaust gas produced by the vehicle's engine using an input connection assembly 204 and the processed gas output from the chambers is conveyed by an output connection assembly 206 to a tailpipe 216 or any other suitable exhaust outlet of the vehicle. The input and output connection assemblies 204, 206 comprise piping, which may be made from metallic materials and which connect the chambers 203 in a predetermined way. Valves 205 and 207, such as individually electromagnetically operated valves, in the input and output connection assemblies 204, 206 are used for directing the flow of exhaust gas through one or more active chambers while the remaining chambers are in standby mode.

In the illustrative embodiment shown in FIG. 2, the system 200 includes five chambers 203a-203e connected with the vehicle exhaust by the input connection assembly 204 in parallel, with each chamber housing two removable cartridges 202 therein connected in series. In particular, the input connection assembly 204 includes a main line 204f for receiving the vehicle exhaust and a plurality of connecting lines 204a-204e connecting the main line 204f with the respective chambers 203a-203e. Each of the connecting lines 204a-204e includes a corresponding valve 205a-205e, and the valves 205a-205e control the flow of the exhaust through the connecting lines 204a-204e to the chambers 203a-203e. Similarly, the output connection assembly 206 of the present illustrative embodiment includes a main outlet, which may be in the form of a tailpipe 216 of the vehicle, and a plurality of connecting lines 206a-206e connecting the respective chambers 203a-203e to the main outlet. Each of the connecting lines 206a-206e includes a corresponding valve 207a-207e, and the valves 207a-207e control the flow of exhaust from the chamber(s) to the main outlet. It is understood that the number of chambers and of the corresponding connecting lines in the input and output connection assemblies may be varied depending on the requirements and size of the vehicle. Moreover, as discussed above, in some embodiments, the cartridges 202 may be connected directly to the input and output connection assemblies 204, 206.

As in the system of FIG. 1, the system 200 includes one or more carbon dioxide sensors or detectors 208 for sensing carbon dioxide concentrations in the exhaust gas prior to conveying the exhaust through the chamber(s) 203, and one or more carbon dioxide sensors or detectors 210 for sensing carbon dioxide concentrations in the processed exhaust gas after carbon dioxide absorption in the cartridges 202. In the embodiment shown, the system includes the carbon dioxide sensor 208 in the main line 204f of the input connection assembly 204, and the carbon dioxide sensor 210 in the outlet line 216 of the output connection assembly 206. However, multiple carbon dioxide sensors 208 may be used on various locations of the input connection assembly and multiple carbon dioxide sensors 210 may be used in various locations of the output connection assembly.

Moreover, the system 200 includes a controller 212 which controls the operation of the system and provides alarms or notices to the operator of the vehicle. In the illustrative embodiment of FIG. 2, the controller 212 is part of the on-board computer of the vehicle which is programmed to control the system's operation. However, in other embodiments, a separate controller may be provided which controls the operation of the system and may interact with the on-board computer of the vehicle. In particular, the controller 212 receives signals, including carbon dioxide detection results from the sensors 208 and 210, and determines the state of the absorber in the active chambers and whether or not the flow of exhaust gas needs to be redirected to one or more chambers in standby mode. The controller 212 also determines, based on the received signals from the sensors 208, 210, whether one or more cartridges 202 needs to be replaced. In certain embodiments, the controller 212 determines the distance driven by the vehicle and/or the approximate amount of fuel used, or determines the amount of fuel used based on the distance driven by the vehicle. In such embodiments, the controller determines, based on the distance driven and/or the amount of fuel used, the state of the absorber in the active chambers, calculates how much of the absorber has been used up or spent, determines whether one or more active cartridges needs to be replaced and/or determines whether the exhaust gas should be redirected to one or more cartridges in standby.

Moreover, the system 200 may include one or more detectors (not shown) for detecting replacement of one or more spent cartridges 202 with a new cartridge or one or more detectors (not shown) for detecting replacement of the absorber in one or more spent cartridges 202. Such detectors may be placed within the chambers 203 and/or within the cartridges themselves, and upon detection of a new cartridge or replacement of the absorber in one or more spent cartridges 202, the sensors provide signals to the controller 212 to indicate replacement of the cartridge(s) or absorber.

As also shown in FIG. 2, the system 200 includes an intercooler 214 which receives exhaust gas from the engine and cools the exhaust before conveying it to the input connecting assembly 204. The intercooler 214 is positioned so that exhaust gas, after leaving a catalytic converter of the vehicle, travels through the intercooler and the intercooler 214 is allowed to be cooled by ambient air. As shown in FIG. 2, an electrically operated fan 215 may also be provided to assist in the cooling, when needed. By cooling the exhaust using the intercooler 214 prior to conveying the exhaust to the chambers 203 and/or cartridges 202, the speed of the absorption reaction between the absorber and the carbon dioxide is improved. This is because the reaction between calcium hydroxide and carbon dioxide is exothermic with an enthalpy of −69.1 kJ/mole and temperature of the absorber increases during the absorption process.

In addition, the intercooler 214 reduces the engine noise from the vehicle, and in the present embodiment, the intercooler 214 replaces the conventional muffler and resonator which would typically be used in the vehicle. Alternatively, the intercooler may be used in combination with the muffler and resonator in the vehicle, or a gas cooling device may be used instead of the intercooler, in combination with the muffler and resonator, in order to cool the exhaust gas prior to conveying it to the chambers and/or cartridges.

When installing the system 200 of FIG. 2 into the vehicle, the intercooler 214 is installed in the space typically used for the muffler and resonator so that the intercooler 214 receives exhaust gas generated by the engine and cools the exhaust gas while also reducing noise. In addition, when the system of FIG. 2 is installed into the vehicle, the chambers 203 and/or cartridges 202 are disposed preferably in the rear area of the vehicle and in close proximity with the vehicle's tailpipe or exhaust pipe. In passenger vehicles, the chambers and/or cartridges may be disposed in the trunk area of the vehicle so as to be easily accessible to the vehicle's operator and to facilitate easy removal and replacement. For example, the chambers and/or cartridges may be disposed along the inner walls of the trunk of the passenger vehicle and separated from the main trunk compartment by an enclosure matching the interior finish of the trunk. In this way, the amount of trunk space taken up by the chambers and cartridges is minimized and the chambers and cartridges remain separated from personal items stored in the trunk and are prevented from shifting. Similarly, in vans and other similar vehicles, the chambers and/or cartridges may be disposed along the walls of the vehicle's storage compartment and separated from the main area of the storage compartment by an enclosure. Alternatively, the chambers and/or cartridges in passenger vehicles and/or vans and the like may be provided outside of the trunk. However, in such cases, the cartridges should be easily accessible to users for removal and replacement. In bus-type vehicles, the chambers and/or cartridges may be installed either in the main passenger compartment of the bus or in the baggage storage compartment of the bus, typically located under the passenger compartment, or outside of the passenger and storage compartments, as long as the cartridges are easily accessible to the operator for removal and replacement. Finally, in light-weight and heavy duty trucks, the chambers and/or cartridges may be disposed either inside the cab or sleeper cabin of the truck or may be provided outside of the cab and sleeper cabin in the area near the exhaust pipe.

The size and number of the cartridges used in the system is dependent on the vehicle type and size. In passenger vehicles, typically between 2 and 8 cartridges of a first size may be installed in the trunk compartment of the vehicle. In one illustrative example, the cartridges for passenger vehicles are sized so as to house therein about 3 kg of absorbent. However, in larger vehicles, such as vans or lightweight trucks, a greater number of cartridges of the first size or a larger second size may be installed. Moreover, the number and size of the cartridges installed in heavy duty trucks and/or busses may be even greater since these vehicles have a greater storage and weight capacity. The size of the cartridges is determined by handling weight and space, while the number of the cartridges is determined by the available space in vehicle, the desired capacity and fuel consumption.

An output of the intercooler 214 is connected to the chambers and/or cartridges installed in the vehicle by the input connection assembly, which includes metal piping suitable for transporting exhaust gas, particularly under heated conditions. In particular, copper piping may be used because of the ease of forming and handling of the pipes, without requiring welding. As discussed above and as shown in FIG. 2, the piping of the connection assembly may be arranged so that the chambers and/or cartridges are connected to the intercooler in parallel, and further, so that groups of serially connected cartridges are connected in parallel relative to one another. In addition, the chambers and/or cartridges installed in the vehicle are also connected to the exhaust outlet, such as the tailpipe, 216 by the output connection assembly which comprises piping for transporting processed exhaust gas to the outside. The input and output assemblies have valves 205, 207 installed therein for controlling the flow of exhaust through active chambers and/or cartridges while other chambers and/or cartridges are in stand by. The valves 205, 207 may be electromagnetically operated valves, that are capable of being individually switched on and off, or any other suitable valves.

As also discussed herein above, carbon dioxide sensors 208, 210 are installed in the input connection assembly and in the output connection assembly so as to detect carbon dioxide concentration in the exhaust gas prior to, and after, being conveyed through the cartridges. In some embodiments, however, only carbon dioxide sensor 210 may be used in the output connection assembly for detecting carbon dioxide concentration in the exhaust gas after it is conveyed through the cartridges. In yet other embodiments, a single sensor or set of sensors with two gas sampling points, upstream and downstream of the cartridges, may be used for detecting carbon dioxide concentration in the exhaust before and after being conveyed through the cartridges. Moreover, some embodiments do not include any carbon dioxide sensors for sensing the carbon dioxide in the exhaust, and in such embodiments, the status of the active cartridges is monitored based on the distance traveled and/or amount of fuel burned by the vehicle.

The controller 212 in the present system may be part of the on-board vehicle computer or may be a separate controller, preferably in communication with the on-board vehicle computer. The controller controls the opening and closing of the valves 205, 207 so as to convey exhaust gas from the intercooler to active chambers/cartridges until the absorbent capacity of the active cartridges falls below the predetermined level and to thereafter change the flow of exhaust gas to one or more chambers/cartridges in standby so as to switch those chambers/cartridges into active mode. When the controller determines that the active cartridges have been used up, or that their absorbent capacity is below the predetermined level, the controller also sends a signal that causes an on-board display of the vehicle to display an alarm or a notice to the vehicle operator indicating that the previously active cartridges need to be replaced. The display of the alarm or notice to replace the previously active cartridges may be delayed for a predetermined time period after the controller changes the flow of exhaust gas to one or more chambers/cartridges in standby, so as to allow the previously active cartridges to cool and to allow safe handling of the cartridges by the user. In addition, the cartridges that have been used up and need to be replaced are determined to be inactive by the controller so that the exhaust gas is not again conveyed through those cartridges until they are replaced.

When all of the cartridges have been used up, the controller sends a signal to cause the on-board display to display an alarm or a notice to the vehicle operator that all of the cartridges need replacement. Moreover, when all of the cartridges are used up, the controller does not switch the exhaust flow from the active cartridges to other cartridges which have been previously determined to be inactive. Instead, in some embodiments, the controller continues to allow the exhaust gas to flow through the previously active cartridges until the vehicle operator replaces some or all of the cartridges with new cartridges. In other embodiments, the controller controls the exhaust gas to be conveyed to a bypass connecting line 218 which connects the main line 204f of the input connection assembly 204 directly to the outlet 216 without conveying the exhaust gas through any of the cartridges. In particular, the controller controls the valves 205, 207 to close and bypass valves 220, 222 to open so that no exhaust is conveyed through the cartridges and the exhaust is conveyed through the bypass connecting line 218. In this way, the cartridges are allowed to cool down so as to enable handling of the cartridges during replacement.

As discussed above, the cartridges are removable and replaceable with new cartridges filled with new absorbent. In such embodiments, the chamber(s) housing the cartridges may be opened or accessed so as to remove used-up cartridges therefrom and to install new replacement cartridges in the appropriate chamber(s). The removal and replacement of cartridges may be done at an appropriate replacement station that makes replacement cartridges available, and appropriate replacement stations may be provided at gas station, truck stops, special recycling stations, shopping centers, parking lots, and the like. During cartridge replacement, the engine may be stopped or running since the spent or used-up cartridges are in the chamber isolated from the exhaust flow.

In other embodiments, as discussed above, the cartridges are not housed by chambers and may be either removable and replaceable with new cartridges, or may include access to the absorbent in the cartridge so as to remove the spent absorbent and to replace it with new absorbent. In the embodiments in which the cartridges include access to the absorbent, the spent absorbent may be removed and replaced with new absorbent using compressed air and fluidized flow of the absorbent granules. This process of removing and replacing the absorbent in the cartridge may be automated.

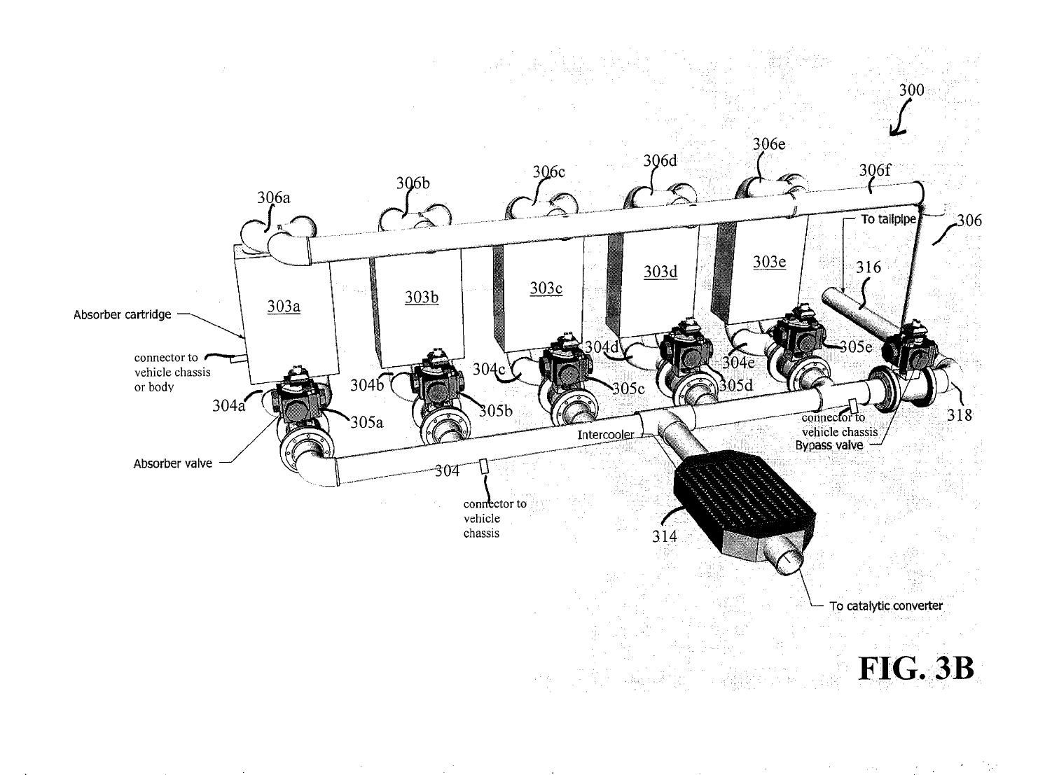

FIGS. 3A-C show perspective, front and side 3-dimensional views of the carbon dioxide system 300 for use in a vehicle. The system 300 is particularly suited for use in a passenger vehicle or a light truck, but may be easily adapted for use in heavy duty trucks, busses, and other vehicles. As shown in FIGS. 3A-3C, the system 300 includes an intercooler 314, an input connection assembly 304, a plurality of cartridges 302 (not visible) housed in a plurality of chambers 303, an output connection assembly 306, a plurality of individually controlled input valves 305, a bypass line 318 with a corresponding bypass valve 320 and an outlet 316. As discussed above, the intercooler 314 is disposed in the vehicle in the place of the muffler and resonator and replaces the muffler and the resonator. The intercooler 314 receives exhaust after it is conveyed through the catalytic converter, and cools the exhaust, while being cooled by ambient air. As discussed above, an electrically operated cooling fan may be added to the intercooler for further cooling the exhaust.

From the intercooler 314, the cooled exhaust is conveyed to the input connection assembly 304, which conveys the exhaust to one or more chambers 303. As shown, the input connection assembly 304 includes a plurality of connection lines 304a-e, each of which includes a respective input valve 305a-e and is connected to a respective chamber 303a-e. The flow and direction of the exhaust to one or more chambers 303 is controlled by a controller (not shown) which controls the input valves 305a-e individually to open and close so that the exhaust is conveyed through one or more active chambers 303a-e while the remaining chambers are in standby mode. In the present embodiment, the input valves 305a-e are electrically or electromagnetically operated valves. During normal operation of the system in some illustrative embodiments, half of the absorber cartridges are active absorber cartridges while the other half of the cartridges are in standby, and when the active absorber cartridges are used up, the controller directs the input valves 305a-e so that the exhaust flows through the standby cartridges and not through the used up cartridges. In other embodiments, the number of active cartridges and cartridges in standby may be varied depending on the configuration of the system, number and size of the cartridges and the exhaust amount.

In the embodiment shown in FIGS. 3A-C, each connection line 304a-e splits into two connecting lines prior to connecting to the respective chamber 303a-e so as to provide better flow distribution through the chamber. However, in other embodiments, each connection line 304a-e may connect to the chamber 303a-e without any splitting, or in yet other embodiments, each connection line 304a-e may be split in more than two lines so as to adjust the flow distribution from the connection line to the chamber 303a-e.

In the embodiment shown in FIGS. 3A-3C, each chamber 303 houses therein one cartridge 302 which is easily removable and replaceable. However, in other embodiments, each chamber 303 may house multiple cartridges connected in series or in parallel with one another. As discussed above, each chamber may include a replacement sensor which senses removal and replacement of the cartridge and provides a corresponding signal to the controller. As discussed above, each cartridge 302 houses therein absorber, such as soda lime, for absorbing carbon dioxide in the exhaust. In this way, when the exhaust is conveyed through the cartridge, the carbon dioxide in the exhaust reacts with the absorber, and exhaust without carbon dioxide or with a reduced concentration of carbon dioxide is output from the cartridge into the output connection assembly 306.

As shown in FIGS. 3A-C, the chambers 303 and cartridges 302 housed therein are arranged so that the exhaust is conveyed from the bottom of the cartridge 302 to the top of the cartridge. In particular, the chamber 303 in the present embodiment includes a bottom surface and a top surface, wherein the respective connecting line of the input connection assembly 304 is coupled to the bottom surface of the chamber and the respective connecting line 306a-e of the output connection assembly 306 is coupled to the top surface of the chamber. In this way, the exhaust gas is conveyed from the bottom of the cartridge to the top of the cartridge and the absorption of the carbon dioxide by the absorber is not negatively affected by settling of the absorber.

In the embodiment shown in FIGS. 3A-C, the output connection assembly 306 includes a plurality of connecting lines 306a-e corresponding to the chambers 303a-e. In the illustrative embodiment of FIGS. 3A-C, each connecting line 306a-e includes two lines connected with the respective chamber 303a-e, and the two lines of the connecting line 306a-e merge into a single connecting line prior to connecting to a main line 306f of the output connection assembly 306. The main line 306f is thereafter connected with the outlet 316, such as a tailpipe of the vehicle. Although not shown in FIGS. 3A-C, each connecting line 306a-e may include a corresponding output valve, individually controlled by the controller so that when the exhaust is controlled to flow through one or more chambers 303a-3, the corresponding output valve(s) are opened, while the output valve(s) corresponding to the chamber(s) in standby are closed so as to prevent the exhaust from flowing into the standby chambers.

As shown in FIGS. 3A-C, the system 300 also includes the bypass line 318 with a bypass valve 320 therein. The bypass line is coupled with the input connection assembly 304 and is directly coupled with the main line 306f of the output connection assembly 306. In this way, the bypass line 318, when the bypass valve 320 is opened, allows the exhaust to be conveyed directly from the input connection assembly 304 to the output connection assembly 306 and the outlet 316, without being conveyed through one or more cartridges. The bypass valve 320, which may be an electronically or electromagnetically controlled valve, is controlled by the controller which keeps the bypass valve 320 closed during operation of the carbon dioxide system 300 and opens the bypass valve 320 after all of the cartridges are spent or if there is a problem or an alarm condition in the system. Moreover, in some embodiments, the operator of the vehicle may control the controller to switch the system 300 on and off, so that the bypass valve 320 is open when the system is ON, unless all of the cartridges are spent or there is an alarm condition in the system, and so that the bypass valve 320 is closed when the system is OFF.

Although not shown in FIGS. 3A-C, the system may also include one or more carbon dioxide sensors or detectors for detecting or sensing the concentration of carbon dioxide in the exhaust. In particular, the carbon dioxide sensor(s) may be provided in the output connection assembly, such as in the main line 306f of the output connection assembly, or may be provided in both the input and output connection assemblies 304, 306.

The controller (not shown) controls the operation of the system 300, and may be provided as a separate system controller or as part of the on-board vehicle computer. As mentioned above, the controller controls the opening and closing of the valves in the input and/or output connection assemblies and of the bypass valve 320 so as to control the flow of the exhaust through one or more active cartridges or through the bypass line 318. As discussed above with respect to FIGS. 1 and 2, when the system 300 is in operation and the exhaust is directed through one or more active cartridges, the controller monitors the absorption status of the active cartridges. In some embodiments, the controller receives signals from the carbon dioxide sensor(s) and based on these signals, the controller determines whether the absorption capacity of the active cartridges is below a predetermined level and/or whether the active cartridges are spent and need replacement. In other embodiments, the controller calculates the approximate absorption capacity of active cartridges and determines whether the active cartridges are spent and should be replaced based on the distance driven by the vehicle and/or based on the amount of fuel used by the vehicle. In yet other embodiments, the controller uses the signals from the carbon dioxide sensor(s) and the distance driven by the vehicle and/or the amount of fuel used by the vehicle for determining the absorption capacity of the active cartridges and whether the active cartridges need replacement. When the controller determines that the active cartridge(s) are spent, the controller controls the input valve(s) 305a-e corresponding to the active cartridge(s) to close and to open one or more other input valve(s) 305a-e and/or output valve(s) corresponding to one or more cartridge(s) in standby so as to redirect the exhaust to the one or more cartridge(s) in standby. If the controller determines that the active cartridge(s) are spent and there are no other cartridge(s) in standby, then the controller controls all input valve(s) 305a-e and/or output valve(s) to close and the bypass valve 320 to open so as to direct the exhaust flow through the bypass line 318. When the controller determines that one or more cartridges is spent, the controller also controls the on-board display of the vehicle to display a notice or an alarm indicating that the one or more cartridges need replacement. The controller also determines whether any of the spent cartridges have been replaced based on signal(s) received from the sensors in the chamber(s) or based on the user's input to the controller. When the controller determines that one or more cartridges have been replaced, the controller updates the on-board display of the vehicle to no longer display a notice or an alarm for the replaced cartridge(s).

When the system 300 of FIGS. 3A-C is installed in a vehicle, the intercooler is disposed in the space for the muffler and resonator and most or all of the connecting lines of the input connector assembly 304 are disposed under the chassis or in the lower part of the chassis of the vehicle and are connected to the chassis of the vehicle by suitable connectors. The chambers 303 with the cartridges 302 housed therein are disposed inside the vehicle body, preferably in the trunk or storage area of the vehicle, and likewise are connected by connectors to the vehicle chassis or to the vehicle body. For example, the chambers may be arranged inside the trunk area and along the outer wall of the trunk area so as to limit the amount of storage space taken up by the chambers. Also, the chambers may be separated from the main storage space by a separator which matches the interior of the trunk and which allows easy access to the chambers. In the illustrative embodiment of FIGS. 3A-C, most of the output connection assembly 306 is arranged in the trunk or storage area of the vehicle and at least a portion of the main connecting line 306f extends outside of the trunk to connect with the outlet or tailpipe 316.

It is understood that the system 300 shown in FIGS. 3A-C is illustrative and may be varied and adapted for individual vehicles. For example, the number of chambers and/or cartridges and their arrangement may be varied depending on the configuration and size of the vehicle. Moreover, the arrangement of the cartridges and/or chambers, the input and output connection assemblies and other components of the system 300 in the vehicle may be varied depending on the arrangement and space requirements of the vehicle.

A prototype of a system similar to the system 300 of FIGS. 3A-3C was tested in a vehicle over time. The prototype included 3 absorber cartridges connected in parallel and the exhaust was conveyed through all of the absorber cartridges. The absorber used in the cartridges was soda lime manufactured by Jorgensen Laboratories, Inc. In addition, the system included a carbon dioxide sensor which sensed carbon dioxide upstream from the absorber cartridges and downstream from the absorber cartridges.

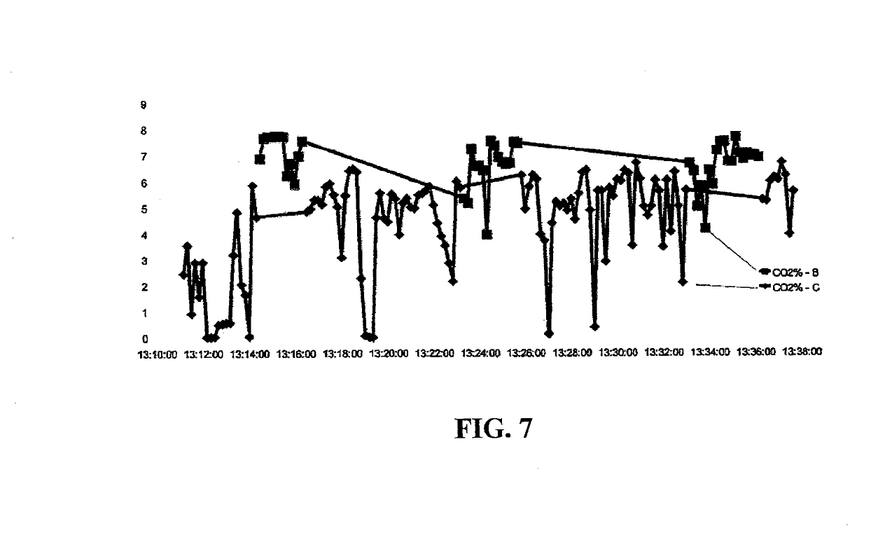

FIG. 7 shows a graph of the carbon dioxide concentrations recorded during the test, in which the X-axis represents relative carbon dioxide concentration and the Y-axis represents testing time. In FIG. 7, CO2%-B represents the concentration of carbon dioxide upstream from the cartridges, while CO2%-C represents the concentration of carbon dioxide downstream from the cartridges. As can be seen in FIG. 7, the concentration of carbon dioxide in the exhaust, i.e. CO2%-B, changes rapidly over time, and these changes in the carbon dioxide concentration are dependent on the road conditions, acceleration and load of the vehicle and other factors. As can also be seen in FIG. 7, the concentration of carbon dioxide in the exhaust after it is conveyed through the cartridge(s), i.e. CO2%-C, is substantially lower than the carbon dioxide concentration before the exhaust is conveyed through the cartridge(s). The carbon dioxide removal efficiency varies from about 40% to about 23% on average, which represents a substantial amount of carbon dioxide removed from the exhaust.

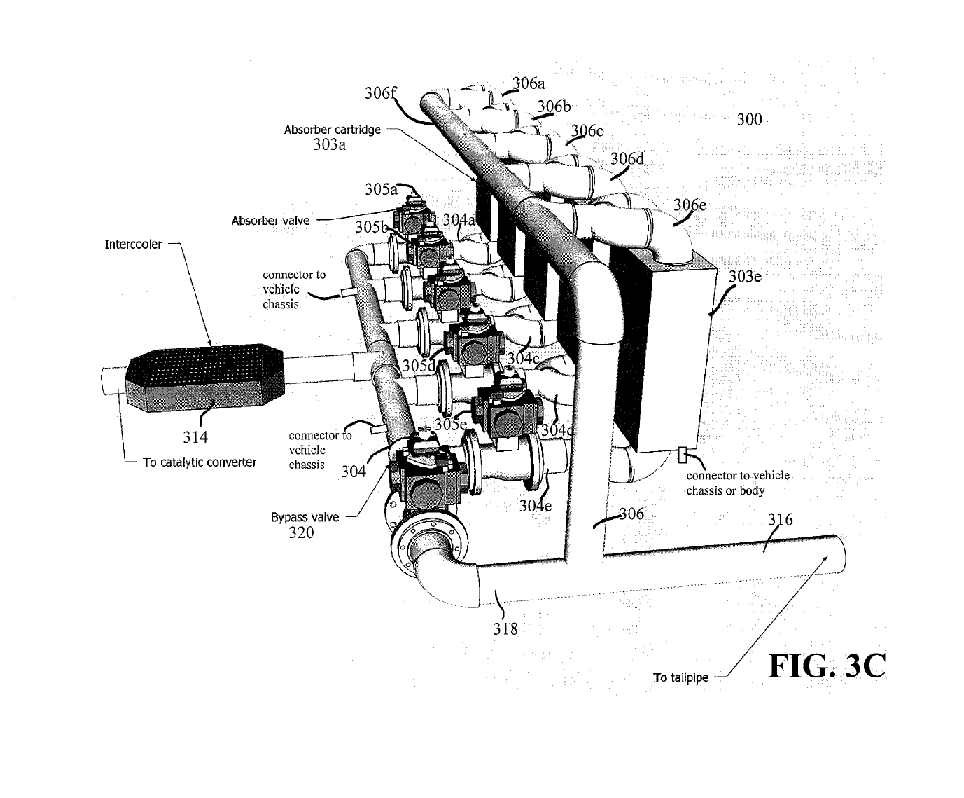

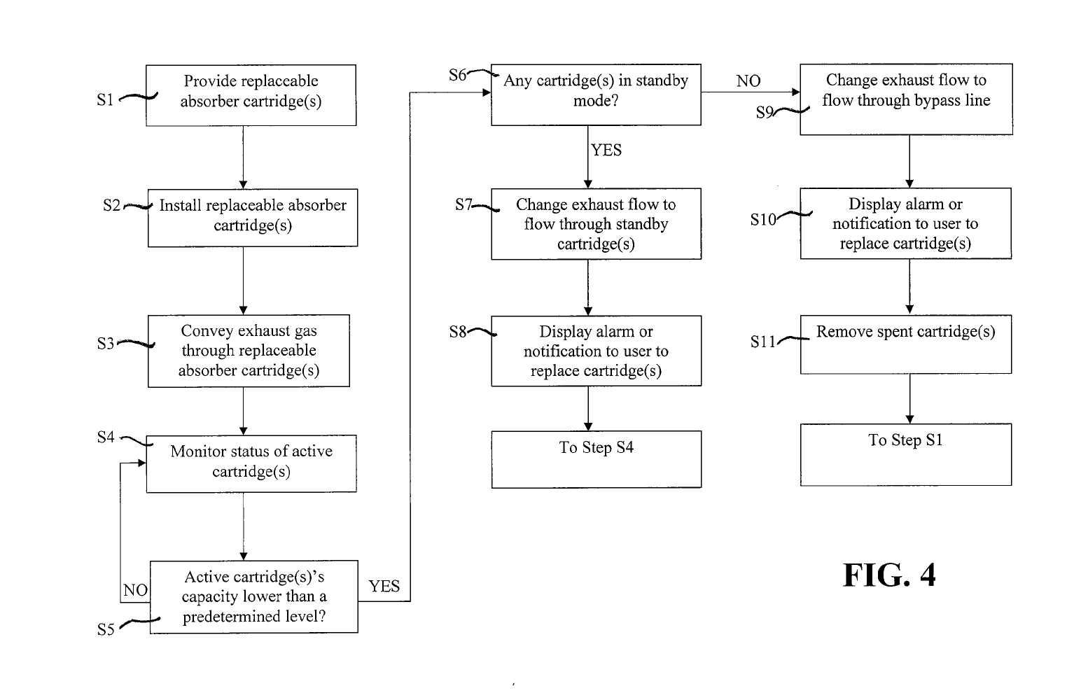

FIG. 4 is a diagram showing steps of a method for removal of carbon dioxide from exhaust gas. The method of FIG. 4 is particularly useful for the transportation sector to remove carbon dioxide emissions from vehicles of different types and will be described below with reference to the systems shown in FIGS. 2 and 3A-C used in a vehicle. However, the method of FIG. 4 may be easily adapted for use in the industrial sector to control emissions from power plants and the like.

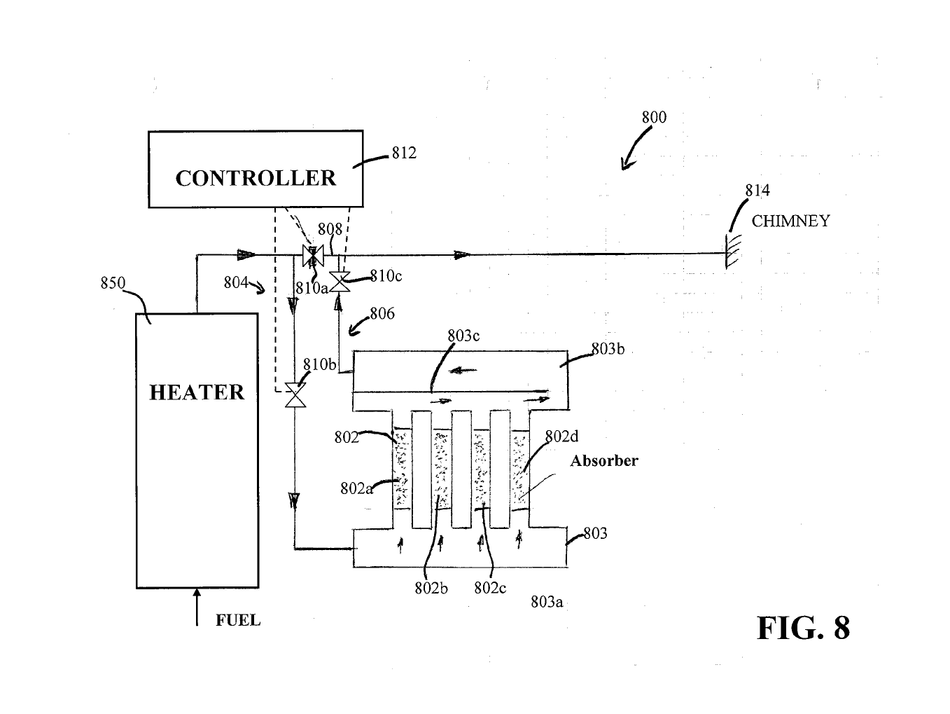

As shown in FIG. 4, in the first step S1 of the method, replaceable absorber cartridges are provided for use in the carbon dioxide removal system, which may be the system shown in FIG. 2 or in FIGS. 3A-C, of the vehicle, or may be the system shown in FIGS. 8-10 of a household heating system. The number and size of replaceable absorber cartridges provided in the first step S1 is preferably varied depending on the type and size of the vehicle or the type and size of the heating system and of the corresponding carbon dioxide removal system. For example, cartridges for use in passenger vehicles, and particularly compact passenger vehicles, may be smaller in size than cartridges for use in trucks, such as heavy duty trucks to enable operators of passenger vehicles to easily remove, lift and replace the cartridges at a replacement station. In contrast, the cartridges in trucks, and particularly in heavy duty trucks, or in the heating system, may be larger in size and a greater number of cartridges may be used, as compared to the number and size of the cartridges in passenger vehicles, so as to provide for greater carbon dioxide removal capacity. The cartridges may be provided in a variety of standard sizes suitable for use in different vehicles, heating systems and/or for different sectors. The replaceable cartridges may be provided at replacement stations, which include but are not limited to gas stations, truck stops, rest stops, shopping centers, parking lots and/or standalone replacement stations. Replacement cartridges may also be provided by an appropriate replacement service, such as an online service or the like, where customers can order replacement cartridges to be delivered to the customer's location and/or pre-order replacement cartridges to be delivered at predetermined times to the customer's location. In addition to delivering the cartridges to the customer's location, the replacement services may also provide cartridge removal and/or installation services for removing spent cartridges and installing new replacement cartridges in place of the spent cartridges. For example, in cases of heating systems, cartridge removal and installation services may be provided by fuel supply companies, such as companies supplying household heating oil or the like. Similarly, the cartridge removal and/or installation services may be provided at replacement stations.

After the replaceable absorber cartridge(s) are provided, the cartridges are installed into the carbon dioxide removal system in step S2. In this step S2, spent cartridges are removed from the system and in their place, new absorber cartridge(s) are installed. In the systems of FIGS. 1 and 2, the new absorber cartridge(s) are installed inside predetermined areas of the chambers so that each chamber houses one or more new absorber cartridge(s). In the systems where the chambers are omitted and the cartridges are coupled directly to the input and output connecting assemblies, such as the system shown in FIGS. 3A-C, the new cartridges are installed in step S2 into predetermined areas of the system and are coupled with the input and output connecting assemblies. The removal of spent cartridges and installation of replacement cartridges may be performed by the operator of the exhaust generating device, such as the vehicle's operator. Also, as mentioned above, the removal and/or installation of cartridges may be provided by the replacement station and/or replacement service.

After the replaceable cartridges are installed in step S2, exhaust gas is conveyed through one or more of the replaceable cartridges in step S3 during operation of the exhaust generating device. As discussed above with respect to FIGS. 1, 2 and 3A-C, the flow of the exhaust gas through the one or more cartridges is controlled by the controller and in certain embodiments, the exhaust is controlled through one or more active cartridges while the remaining cartridges are in standby mode.

When the exhaust gas is conveyed through one or more active cartridges in step S3, the status of the active cartridges is monitored in step S4 to ensure that the active cartridges are properly operated. As discussed above, the monitoring is performed by the controller based on at least signals received by the controller from one or more carbon dioxide sensors. When the controller monitors the status of the active cartridges, the controller determines in step S5 whether the capacity of the active cartridge(s), through which the exhaust gas is being conveyed, is lower than a predetermined level. The determination in step S5 is made based on the signals received from the carbon dioxide sensor(s) which sense concentration of carbon dioxide in the exhaust after the exhaust is conveyed through the active cartridges, and in some embodiments, also sense carbon dioxide concentration in the exhaust before the exhaust is sent to the cartridges. If it is determined in step S5 that the active cartridge(s)'s capacity is not lower than the predetermined level, then the operation returns to step S4 in which the status of the active cartridges is continuously monitored until it is determined that the capacity of the active cartridges is lower than the predetermined level.

If, however, it is determined in step S5 that the capacity of the active cartridges is lower than the predetermined level, then the operation proceeds to step S6 in which it is determined whether there are any cartridges in standby mode. The determination in step S6 is performed by the controller of the system. As discussed above, after one or more cartridges are used up or spent, the controller makes those cartridges inactive so that the exhaust is not conveyed through the spent cartridges before they are replaced. The controller may also receive signals from one or more sensors indicating that one or more spent cartridges have been replaced. Based on the number of cartridges that are inactive and/or based on receipt or non-receipt of signals indicating replacement of one or more cartridges, the controller determines in step S6 whether there are any cartridges in standby mode.

If it is determined in step S6 that there are cartridges in standby mode in the system, then the operation proceeds to step S7 in which the exhaust flow is changed so that the exhaust is conveyed through one or more standby cartridges. As discussed above with respect to FIGS. 1, 2 and 3A-C, the controller controls the flow of the exhaust and in step S7, the controller controls appropriate valves 205, 207 corresponding to active cartridges to close so as to block the flow of exhaust to the active cartridges, and controls appropriate valves 205, 207 corresponding to one or more standby cartridges to open so as to convey the exhaust therethrough.

After the exhaust flow is changed to one or more standby cartridges in step S7, an alarm or a notification is displayed to the operator of the exhaust generating device in step S8 to notify the operator that one or more cartridges need replacement. The alarm or notification may also advise the operator that the exhaust flow was changed to one or more standby cartridges in step S7, how many cartridges need replacement, and how many cartridges are still in standby. As discussed above, the alarm or notification in step S8 may be displayed or activated after a predetermined time period has passed following the exhaust flow change in step S7 so as to allow previously active cartridge(s) to cool off for easy handling and replacement of spent cartridges. In a vehicle carbon dioxide removal system, such as the system shown in FIG. 2, the alarm or notification in step S8 may be displayed by the on-board computer on the on-board display, such as the vehicle's dashboard. In a heating system carbon dioxide removal system, the alarm or notification in step S8 may be shown on any suitable display either part of the heating system or external to the heating system. After the alarm or notification is displayed in step S8, the operation returns to step S4 to monitor the status of the newly active cartridge(s) while the exhaust is being conveyed therethrough.

Although not shown in FIG. 4, after the alarm or notification is displayed to the operator in step S8, the operator can remove spent cartridges and replace them with new cartridges. The removal and replacement of spent cartridges may be performed at any point after one or more cartridges is used up or spent, and after the flow of exhaust is changed to flow through one or more standby cartridges.

If in step S6, it is determined that there are no cartridges in standby mode, then the operation proceeds to step S9 in which the exhaust flow is changed to flow through the bypass line which directly connects the input and output connection assemblies bypassing the cartridges. As discussed above with respect to FIG. 2 and FIGS. 3A-C, the controller controls the exhaust gas flow and causes the exhaust to flow through the bypass line by closing the valves 205, 207 leading to and from the cartridges and by opening the valves 220, 222 leading to and from the bypass line.

After the exhaust flow is changed to the bypass line in step S9, an alarm or a notification is displayed to the user or operator of the exhaust generating device to replace all cartridges in step S10. As discussed above, the controller controls the activation and/or display of the alarm or notification and in a vehicle carbon dioxide removal system, such as the one shown in FIGS. 2 and 3A-C, the controller controls the alarm or notification to be displayed to the vehicle operator on the on-board display such as the vehicle's dashboard. In a household heating system carbon dioxide removal system, the alarm or notification may be displayed on any suitable display which is either part of the heating system or external to the heating system. As also discussed above, in some embodiments, the alarm or notification of step S10 may be activated and displayed after a predetermined time period has passed following the change in the exhaust flow to the bypass line. In this way, the spent cartridges are allowed to cool so that the operator is able to handle and replace the cartridges.

As discussed above, in alternative embodiments, the flow of exhaust may be continued through the active cartridges, without changing it to the bypass line. In such embodiments, the operation would proceed from step S6 directly to step S10 and the notification or alarm would be displayed to the operator while the exhaust continues to flow through the active cartridge(s).

After the notification or alarm is displayed in the step S10, the operator of the exhaust generating device would have an opportunity to remove spent cartridge(s) in step S11 from the system. In the embodiments in which the cartridges are installed in chambers, the removal of the spent cartridges is accomplished by accessing or opening the chambers and taking out the spent cartridges. In some embodiments, the cartridges may need to be also disconnected from the input and/or output connection assemblies prior to removal of the cartridges, particularly in the embodiments in which the chambers are omitted. After the cartridges are removed in step S11, the operation returns to step S1 in which replacement cartridges are provided for installation in place of the removed cartridges. The steps of removing the spent cartridges S11, providing replaceable cartridges S1 and installing replaceable cartridges S2 may be performed at appropriate replacement stations or by the replacement service providers.

After the spent cartridges are removed from the exhaust generating device(s), these cartridges may be refilled or regenerated by the replacement stations, replacement service providers or outside providers so that the refilled or regenerated cartridges may be reused. When the cartridges are refilled, spent absorbent and reaction products are removed from the cartridges, and the cartridges are filled with fresh absorbent. When the cartridges are regenerated, spent absorbent is removed from the cartridges and is regenerated by an appropriate regeneration process. The regeneration process will vary depending on the absorbent used in the cartridges. However, when soda lime is used as the absorbent, the absorbent is regenerated by heating the spent absorbent to 900-1000° C. to release the carbon dioxide and to convert calcium carbonate back to calcium oxide. Released carbon dioxide produced from this regeneration reaction may be stored in a compressed state and may subsequently used for other functions. For example, compressed carbon dioxide may be pumped into a body of water, such as an algae lake, where the carbon dioxide may be used for photosynthesis reactions and the like. Spent absorbent which is not regenerated may also be used in other applications, such as construction, industrial and chemical applications as discussed in more detail below.

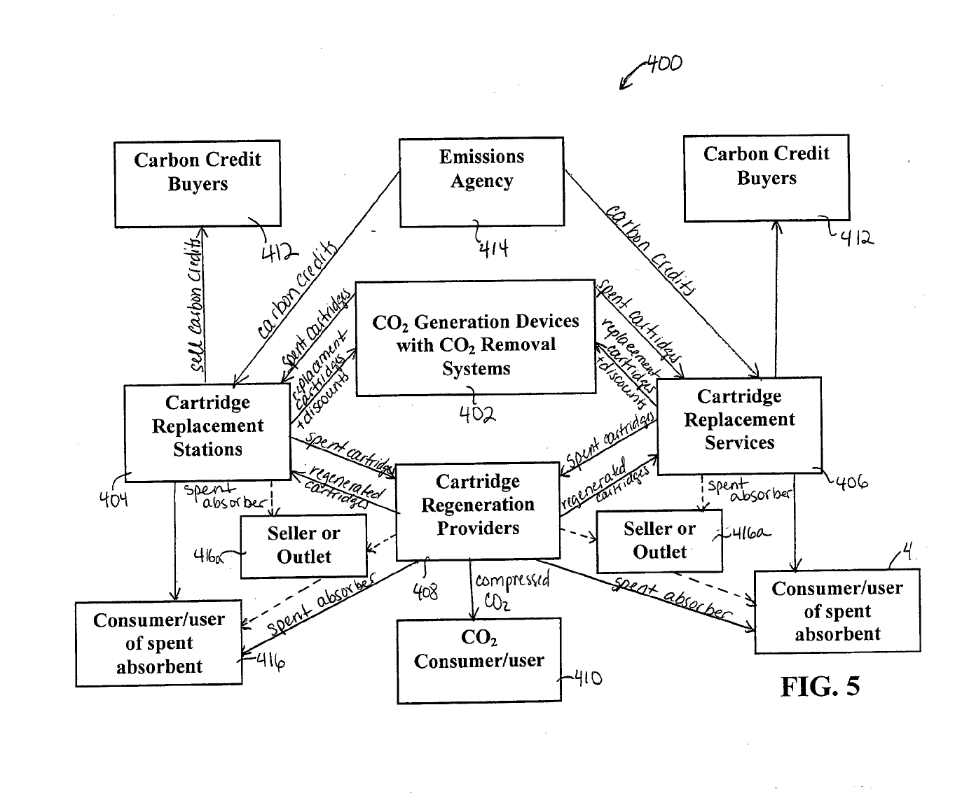

The present invention further contemplates a business system and method for removal of carbon dioxide from exhaust using the carbon dioxide removal system and method of FIGS. 1-4. FIG. 5 shows one embodiment of the business system for removal of carbon dioxide from exhaust and using the carbon dioxide removal system of FIGS. 1-3C. As shown in FIG. 5, the entities involved in the business system 400 include carbon dioxide or exhaust generation devices 402, cartridge replacement stations 404, cartridge replacement service providers 406, cartridge regeneration providers 408, carbon dioxide users or consumers 410, spent cartridge consumers or users 416, one or more emissions agencies 414 and carbon credit buyers 412. In the system of FIG. 5, the carbon dioxide or exhaust generation devices 402 include vehicles, such as passenger automobiles, light trucks and heavy duty trucks, household heating systems, water heating systems and industrial plants which produce exhaust with carbon dioxide as a byproduct of industrial processes, such as combustion processes. Each of these devices 402 produces exhaust with carbon dioxide and includes the carbon dioxide removal system of FIGS. 1-3C for removing at least a portion of the carbon dioxide produced by the device 402. As discussed above, the carbon dioxide removal system utilizes absorbent cartridges which are removable and replaceable with new or regenerated cartridges. In addition, as discussed above, the cartridges for the carbon dioxide removal system may be provided in a variety of standard sizes based on the type and size of the carbon dioxide generation device 402.

Operators of carbon dioxide generation devices 402 can remove and replace spent cartridges at cartridge replacement stations 404 or can request services that include removal and replacement of spent cartridges through the cartridge replacement services 406. As discussed above, spent cartridges are removed and are collected at the cartridge replacement stations 404 and/or at the cartridge replacement services 406, and new cartridges may be purchased by device operators of the carbon dioxide generation devices 402 at the stations 404 or services 406. In some embodiments, instead of removing and replacing the cartridges, the cartridges may be opened at the cartridge replacement stations 404 or by the cartridge replacement services 406 to remove spent absorbent and to replace the spent absorbent with new absorbent. In such embodiments, the stations 404 or services 406 collect the spent absorbent and provide new absorbent by refilling the cartridges in the carbon dioxide generation devices 402.

As shown in FIG. 5, the cartridge replacement stations 404 and cartridge replacement services 406 provide spent cartridges and/or spent absorbent to cartridge regeneration providers 408 which remove spent absorbent from the cartridges and/or regenerate the spent absorbent. In the embodiments of the carbon dioxide removal systems which use soda lime absorbent, the cartridge regeneration providers 408 regenerate the soda lime absorbent by heating the spent absorbent to above 825 degrees C. so as to convert the carbonate produced as a result of the reaction with the carbon dioxide back to calcium oxide and to release captured carbon dioxide. The regeneration reactions for regenerating spent soda lime absorber include one or more of the following reactions:

CaCO₃→CaO+CO₂ (Equation 7)

Na₂CO₃→Na₂O+CO₂ (Equation 8)

K₂CO₃→K₂O+CO₂ (Equation 9)

The resulting oxides can then be combined with water to form the hydroxides used in the absorber.

During the regeneration process, cartridge regeneration providers 408 capture the carbon dioxide released from the spent absorbent during the regeneration process and compress the captured carbon dioxide. The compressed carbon dioxide may then be provided to a carbon dioxide consumer or user 410. Carbon dioxide consumers or users 410 include, but are not limited to, algae farms, which use carbon dioxide in algae lakes or the like, fire extinguisher manufacturers, refrigeration and heating manufacturers and maintenance industry, hospitals, food and beverage industry, pharmaceutical and chemical industry, oil industry, construction industry and agricultural and biological industry. Carbon dioxide may be used by the consumers or users for making carbonated beverages and leavening agents, inflating bicycle tires, making pressurized CO₂ canisters for use in life jackets, airguns, paintball markers, etc., for blasting in coal mines, in dry ice for use in wine making processes and for use as a refrigerant, in pneumatic systems in pressure tools, in fire extinguishers and other fire protection systems, to provide an atmosphere during welding, as a solvent in chemical processing, as an ingredient in production of chemical compounds, such as urea, carbonates, and sodium salicylate, for providing an atmosphere for plants to conduct photosynthesis, in industrial gas lasers, in enhanced oil recovery, for enhanced coal bed methane recovery, for pH control in swimming pools and other bodies of water, etc.

As shown in FIG. 5, the cartridge regeneration providers 408 also provide regenerated cartridges to the cartridge replacement stations 404 and/or cartridge replacement services 406, which in turn, make the regenerated cartridges available for carbon dioxide generation devices 402.

In some embodiments of the system, the cartridge replacement stations or services 404, 406 and/or cartridge regeneration providers 408 provide spent absorber from the spent cartridges, without regenerating the spent absorber to release carbon dioxide, to spent absorber consumers or users 416 directly or indirectly through one or more designated sellers or outlets 416a. In particular, when Calcium Hydroxide is used as the absorber, the spent absorber comprises mostly calcium carbonate, with small amounts of other metal carbonates, and has a composition similar to that of the mineral limestone. The spent absorber may be utilized as a raw material or as a component in a variety of applications. Since, as described above, the absorber is in the form of granules, the spent absorber would be most useful in applications that involve crushing or grinding the limestone mineral before use.

Since the spent absorber is in solid and stable form, the spent absorber may be easily stored and made available in many distributed locations as a product to consumers and users thereof 416. Moreover, because the use of absorber cartridges is intended to be widespread, the spent absorber may be provided to the consumers either directly at the cartridge replacement stations or services 404, 406 or cartridge generation providers 408 which collect the spent absorber, or at nearby seller's or outlet locations 416a. As a result, the amount of transport required to provide the spent absorber product to the user's or consumer's location is reduced, and thus reducing transportation costs and emissions associated therewith. For example, limestone is conventionally obtained in quarries and needs to be transported to the place of usage. However, in the system of FIG. 5, limestone, comprising the spent absorber, would be made available at numerous locations in proximity to the location where it is collected and in proximity to the consumer or user thereof 416, so that the consumer or user may select the closest location to its place of usage and thus reduce transportation requirements. The reduction in the transportation costs allows the seller of the spent absorber to offer the spent absorber at a competitive price relative to the naturally quarried mineral limestone.

Consumers or users of spent absorber 416 may use the spent absorber in a variety of applications, including but not limited to: production of quicklime (calcium oxide) or slaked lime (calcium hydroxide); production of Portland cement in which the spent absorber is mixed with shale, sand and other components and heated in a kiln; in blast furnaces to remove iron from iron ore; as a flux material in a process of smelting and refining materials where the spent absorber combines with impurities to form slag; as a reagent in flue gas desulfurization, where the spent absorber reacts with sulfur dioxide to remove sulfur from flue gas; in glass making; as an acid neutralizer, particularly for treating acidic soils; as a filler in paper, paint, rubber and plastics; as a filter stone in sewage treatment systems; in production of roofing materials, coating asphalt impregnated shingles and other roofing materials; as a source of calcium in livestock after being purified, particularly in dairy cattle ad poultry, as an aggregate in road construction and in concrete; as mine safety dust, after being ground to a fine powder, to be sprayed on exposed coal surfaces in coal mining in order to improve the safety of the mine; and many other applications. In addition, the spent absorber may be used in general construction, typically in applications and materials requiring sand or similar materials. For example, spent absorber may be used in combination with cement, and in place of sand, in manufacturing bricks or similar building structures and materials, or may also be used in manufacturing sheetrock-type materials and structures. The resulting building structures and materials are stronger and lighter in weight than conventional brick and sheetrock materials. In addition, the building structures and materials manufactured with the spent absorber are fireproof and are capable of withstanding high heat conditions.

In order to provide an additional incentive for removal of carbon dioxide from exhaust, certain agencies 414, e.g. emissions agencies, provide carbon credits for entities that qualify as carbon off-setters. Cartridge replacement services 406 or cartridge replacement stations 404, which collect spent cartridges with captured carbon dioxide and provide replacement cartridges for carbon dioxide generation devices, receive carbon credits from the emissions agencies 414 for the carbon dioxide collected by the spent cartridges. Carbon credits received by the cartridge replacement stations 404 and services 406 can then be sold to other entities 412, i.e. carbon credit buyers, on the market. In this way, the ability to obtain and sell carbon credits for the carbon dioxide collected by the spent cartridges provides an incentive for cartridge replacement stations 404 and services 406 to provide the spent cartridge removal and/or cartridge replacement services to operators of carbon dioxide generation devices.

Moreover, in order to provide a further incentive to the operators of carbon dioxide generation devices to regularly remove spent cartridges from the devices 402 and to replace them with new cartridges, cartridge replacement stations 404 and/or services 406 provide discounts to operators of carbon dioxide generation devices for a variety of products and services. For example, cartridge replacement stations 404 and/or services 406 may offer discounts to device operators on gasoline or fuel, or discounts on replacement cartridges, in order to incentivize prompt removal and replacement of spent cartridges.

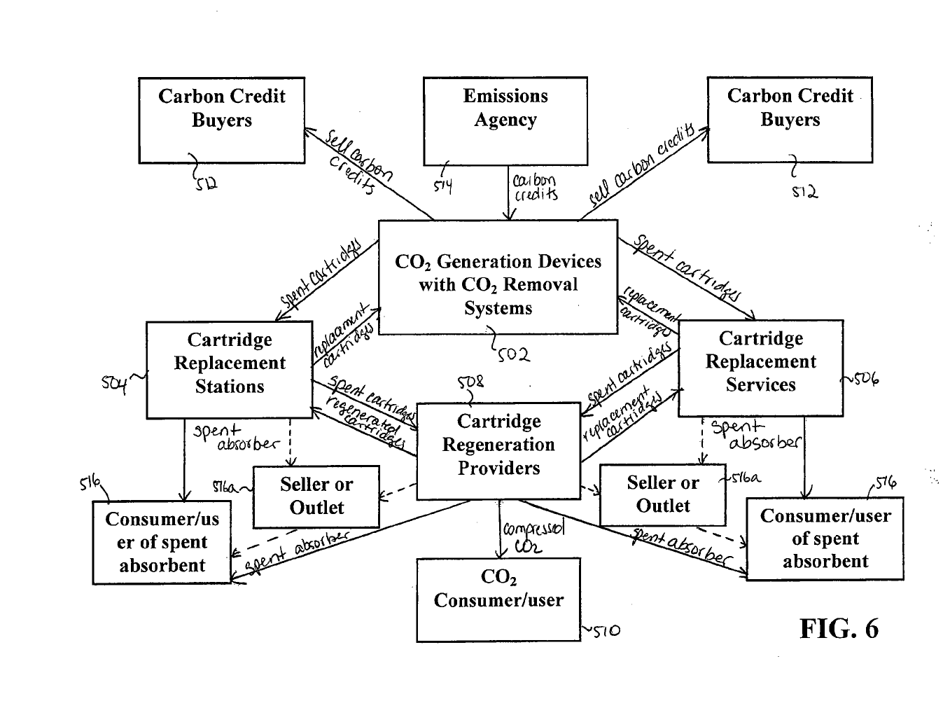

FIG. 6 shows another embodiment of the business system for removal of carbon dioxide from exhaust and using the carbon dioxide removal system of FIGS. 1-3C. As in FIG. 5, the entities involved in the business system 500 include carbon dioxide or exhaust generation devices 502, cartridge replacement stations 504, cartridge replacement service providers 506, cartridge regeneration providers 508, carbon dioxide users or consumers 510, spent absorber users or consumers 516, one or more emissions agencies 514 and carbon credit buyers 512. Most of the entities of the business system 500 of FIG. 6 operate in the same way as the entities of the business system 400 of FIG. 5. That is, in the system 500 of FIG. 6, the CO₂/exhaust generation devices 502 include the system of FIGS. 1-3C and use replacement cartridges and/or cartridges that allow replacement of absorber. As shown in FIG. 6, the operators of the devices 502 use the cartridge replacement services 506 or cartridge replacement stations 504 for removal and replacement of cartridges or absorber, wherein the cartridge replacement stations 504 and cartridge replacement services 506 collect spent cartridges and make replacement cartridges or absorber available to the operators of the devices 502. The cartridge replacement stations and services 504, 506 can send collected spent cartridges to cartridge regeneration providers 508 or may regenerate the cartridges on-site, and any carbon dioxide released during the regeneration process is compressed and provided to a CO₂ consumer or user 510. Also, the cartridge replacement stations and services 504, 506 and the cartridge regeneration providers 508 can provide spent absorber from spent cartridges, without regenerating the absorber, to spent absorber users or consumers 516, either directly or through designated sellers or outlets 516a. The spent absorber users or consumers 516 can use the spent absorber for a variety of applications as discussed herein above.

In the system 500 of FIG. 6, the owners and/or operators of CO₂/exhaust generation devices 502 receive carbon credits from one or more emissions agencies 514 and can sell them to carbon credit buyers 512. In particular, the owners of CO₂/exhaust generation devices in this embodiment are typically owners of a power plant, owners of buildings that require a certain amount of heating or owners of a number of vehicles, such as a company that owns multiple vehicles and uses those vehicles for its business operations. Owners of CO₂/exhaust generation devices may include bus companies, truck companies, taxi companies, transportation companies and other corporate owners of vehicles, large scale building and property owners or power plant or industrial plant owners/operators. Such owners greatly benefit from the carbon credit programs since such programs provide carbon credits for such owners proportional to the amount of carbon dioxide emissions reduced and such carbon credits may be sold to other companies. In addition, such owners would be recognized by the community and their consumers as eco-friendly or as friendly to the environment, promoting the goodwill of the company. In this way, the use of the carbon dioxide removal systems of FIGS. 1-3C incentivize the owners of CO₂/exhaust generation devices to install and properly use the carbon dioxide removal systems in their devices.

It is understood that the business systems 400, 500 of FIGS. 4 and 5 and their operation may be varied so as to provide the most incentives to the owners and operators of the CO₂/exhaust generation devices and other entities involved in the systems. Moreover, the business systems of FIGS. 4 and 5 may be combined so that in some cases, the owners/operators of CO₂ generation devices may receive carbon credits, such as where the owners/operators are companies or larger entities, while in other cases, the cartridge replacement stations and/or services receive carbon credits, such as where the owners/operators are individuals, e.g. individual vehicle operators. In yet other embodiments, the consumers or users of CO₂ or the consumers or users of spent cartridges may receive carbon credits, either instead or in addition to the other entities in the business system.

Although the above-described systems and methods are described as having a solid absorbent for removing carbon dioxide from the exhaust, it is understood that any suitable constituent capable of removing at least a portion of carbon dioxide from the exhaust may be used in the cartridges instead of, or in addition to, the above-described solid absorbent. Such constituents may be in a form of a fluid, including a solid, a liquid, a gas or a mixture thereof, and may remove carbon dioxide from the exhaust by absorption, adsorption or any other suitable means. Examples of such constituents include, but are not limited to, solutions of alkali hydroxides or aqueous solutions of amines capable of removing at least some carbon dioxide from the exhaust.

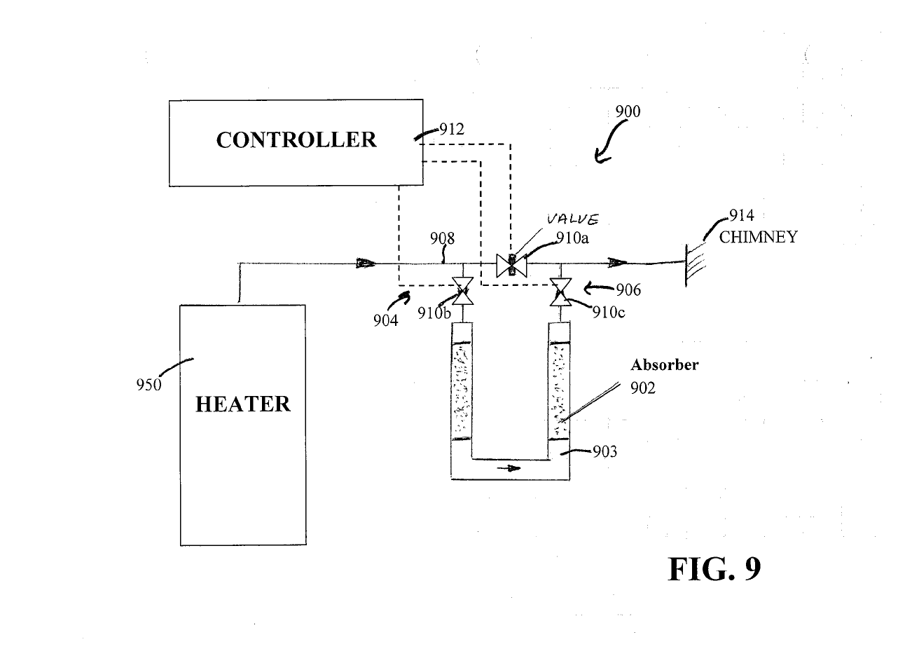

As discussed above, the carbon dioxide removal system of FIG. 1 may be adapted for other uses, including industrial use or household use. FIGS. 8 and 9 show illustrative embodiments of the carbon dioxide removal system of FIG. 1 adapted for household use with a household heater or similar carbon dioxide generating device or assembly. As shown in FIG. 8, the carbon dioxide removal system 800 comprises one or more absorption cartridges or containers 802 that house therein absorbent material for absorbing carbon dioxide, an input assembly 804 that connects exhaust gas output from a carbon dioxide generating device 850 with the cartridges 802 of the system 800 and an output connection assembly 806 which connects the cartridges 802 with the outside for outputting processed exhaust gas. In the embodiment shown in FIG. 8, the carbon dioxide generating device 850 is a household heater, such as an oil heating device, gas furnace, oil and/or gas water heater, or a water heating system. However, it is understood that the system 800 of FIG. 8 may be used with other devices that generate and output exhaust gas with carbon dioxide. As discussed above with respect to FIG. 1, the absorbent in the cartridges 802 may comprise one or more alkali hydroxides and/or alkali earth hydroxides, including, but not limited to calcium hydroxide, sodium hydroxide and potassium hydroxide. In the present illustrative embodiment, the absorber comprises lime, and in particular, soda lime. As also discussed above, the absorbent material is in solid form and preferably, in granular form, with granules sized so as to provide sufficiently quick rate of carbon dioxide absorption without causing a significant increase in the back pressure of the exhaust gas.

As shown in FIG. 8, the cartridges or containers 802 are disposed in a housing 803, and may be either removable from the housing 803 so as to be replaced with new like cartridges or accessible from the housing so as to allow for the spent absorbent material to be removed from one or more cartridges and for the new absorbent material to be added to the one or more cartridges. In other embodiments, the cartridges 802 may be disposed in a plurality of chambers or the like, and may be either removable or accessible from the chambers. In the illustrative embodiment of FIG. 8, the cartridges 802 are disposed in the housing in parallel so that the exhaust gas supplied from the input assembly 804 is provided simultaneously to all of the cartridges 802. However, it is understood that the total number of cartridges housed by the housing and the number of cartridges that may be used simultaneously in parallel may be varied. For example, valves or similar flow control devices may be used within the housing so as to selectively control the flow of the fuel through one or more of the cartridges.

As shown in FIG. 8, the housing 803 includes an inlet area 803a which receives exhaust gas from the input assembly 804 and an outlet area 803b which receives processed exhaust gas after the exhaust gas leaves the cartridges 802. In the embodiment shown, the housing 803 includes a baffle or similar device 803c in the outlet area 803b for directing the flow of the processed exhaust gas after the exhaust gas leaves the cartridges 802. In this illustrative embodiment, the baffle extends from a side of the housing closest to a first cartridge 802a which is closest to the input assembly 804 supplying the exhaust gas to the housing 803 and in the direction toward an opposing side closest to a fourth cartridge 802d which is furthest away from the input assembly 804. In this way, the processed exhaust leaving the cartridges 802a-d is directed to flow around the baffle 803c to reach the output connection assembly 806, and the flow distribution of the exhaust gas input by the input assembly 804 is thereby controlled so as to be evenly or substantially evenly distributed among the cartridges 802a-d. In other embodiments, the configuration of the baffling in the outlet area 803b may be varied in order to achieve a desired flow distribution. In yet other embodiments, no baffling is provided in the outlet area 803b, and instead, exhaust gas flow into individual cartridges 802a-d may be controlled individually, such as by providing flow control devices or baffling in the inlet area 803a of the housing.

Although the illustrative embodiment of FIG. 8 includes four cartridges 802a-d disposed in parallel relative to one another, it is understood that the number and arrangement of the cartridges may be varied. For example, the cartridges may be arranged in groups, so that each group of cartridges includes two or more cartridges disposed in series, and the groups are arranged in parallel relative to the other groups. In other embodiments, the cartridges may be arranged in series. Moreover, multiple housings may be used for housing the cartridges so that some of the cartridges are housed in one housing while other cartridges are housed in one or more other housings. For example, in some embodiments, multiple housings with a cartridge arrangement shown in FIG. 8 may be used so as to allow switching of the exhaust flow from the carbon dioxide generating device between different housings. In such embodiments, the number of housings 803 and the number of cartridges housed in each housing 803 would be dependent on the size and requirements of the carbon dioxide generating device.

As shown in FIG. 8, the exhaust gas from the carbon dioxide generating device 850 to the housing 803 is supplied through the input connection assembly 804, which includes one or more connection lines. In addition, processed exhaust gas output from the housing 803 is supplied through the output connection assembly 806 to an outlet, such as a chimney 814, a vent or the like. In FIG. 8, the system 800 includes a bypass connection 808 between the input connection assembly 804 and the output connection assembly 806, which allows all or a portion of the exhaust gas from the carbon dioxide generating device to be conveyed from the input assembly 804 to the output assembly 806 without passing through the housing 803. The operation of the bypass connection and/or the amount of exhaust conveyed through the bypass connection 808 is controlled by a valve 810a or a similar flow control device. In addition, a second valve 810b or a similar flow control device, is provided in the input assembly 804 so as to control the flow of the exhaust to the input assembly 804 and to the cartridges, and a third valve 810c or a similar flow control device, so as to control the flow of the exhaust through the output assembly 806. When the exhaust is to be conveyed through the bypass connection 808, the valve 810a is opened so as to direct the exhaust through the bypass connection 808, while the second and third valves 810b, 810c are closed so as to prevent the exhaust from entering the input and output connection assemblies 804, 806. In some embodiment, the flow of the exhaust may be controlled so as to convey a portion of the exhaust through the bypass connection 808 while the remaining portion of the exhaust is conveyed to the cartridges. In such embodiments, the amount of the opening of the valves 810a-c is controlled so as to control the relative amounts of the exhaust portions conveyed through the bypass connection and through the cartridges.

As also shown in FIG. 8, the system 800 includes a controller 812 for controlling the operation of the system, including the opening and closing of the valves 810a-c and of any other flow control devices in the system. As in the system 100 shown in FIG. 1, the controller 812 controls the flow of exhaust gas to the housing 803 and through one or more cartridges 802 based on measured or predicted absorption capacity of active cartridges. In some embodiments, one or more detectors (not shown) may be provided in the input assembly 804 for detecting the concentration of carbon dioxide in the exhaust gas prior to being conveyed through one or more cartridges 802 and/or in the output assembly 806 for detecting the concentration of carbon dioxide in the processed exhaust gas after being conveyed through one or more cartridges 802. In such embodiments, the controller 812 receives the signals from the one or more detectors and uses these signals to determine whether the absorbent in active cartridges have been spent and needs to be replaced. In other embodiments, the controller 812 monitors the amount of fuel used by the carbon dioxide generating device and/or the amount of exhaust output by the carbon dioxide generating device, and based on the amount of fuel used and/or the amount of exhaust output, determines when the absorbent in the active cartridge(s) needs replacement.

When the controller 812 determines that the absorbent in the active cartridge(s) needs replacement, the controller outputs an alert signal to the user or operator of the carbon dioxide generating device indicating the need for such replacement. In some embodiments, the controller 812 also controls the flow of the exhaust gas to the cartridge(s) so as to redirect the flow of the exhaust to other unspent cartridge(s), or to other housings with unspent cartridge(s) by controlling the opening and closing of appropriate flow control devices (not shown) of the system. Alternatively, the controller 812 controls the flow of the exhaust gas from the carbon dioxide generating device 850 to the bypass connection 808 so as to bypass the cartridge(s). In particular, when the controller 812 determines that the absorbent in all of the cartridges 802 in the system 800 has been used up and needs replacement, the controller 812 controls the valve 810a to open and the valves 810b, 810c to close.

FIG. 9 shows another configuration of the carbon dioxide removal system of FIG. 1 adapted for household use with a household heater or similar carbon dioxide generating device or assembly. As in FIG. 8, the system 900 of FIG. 8 includes one or more absorption cartridges or containers 902 that house therein absorbent material for absorbing carbon dioxide, an input assembly 904 that connects exhaust gas output from a carbon dioxide generating device 950 with the cartridges 902 of the system 900 and an output connection assembly 906 which connects the cartridges 902 with the outside for outputting processed exhaust gas. In the embodiment shown in FIG. 9, the carbon dioxide generating device 950 is a household heater, such as an oil heating device, gas furnace, oil and/or gas water heater, or a water heating system. However, it is understood that the system 900 of FIG. 9 may be used with other devices that generate and output exhaust gas with carbon dioxide. The absorbent used in the cartridges 902 is the same or similar to the absorbent used in the system of FIG. 1 and FIG. 8.

In the embodiment shown in FIG. 9, the cartridges 902 are disposed in series within a housing 903 and are either removable from the housing 903 so as to be replaced with new like cartridges or accessible from the housing so as to allow removal and replacement of the spent absorbent material. Although the embodiment of FIG. 9 schematically shows two cartridges disposed in series, it is understood that the number of cartridges 902 may be varied and that the cartridges may be housed in the same housing 903 or in different housings. Moreover, even though the embodiment of FIG. 9 shows one group of cartridges 902 disposed in series, the number of groups of cartridges 902 may vary so that, for example, a plurality of groups of cartridges, each housed within a separate housing, may be disposed in parallel with respect to other groups of cartridges, and the flow of exhaust gas may be switched between the different groups of cartridges as needed.

As shown in FIG. 9, the exhaust gas from the carbon dioxide generating device 950 to the housing 903 is supplied through the input connection assembly 904, which includes one or more connection lines, and processed exhaust gas output from the housing 903 is supplied through the output connection assembly 906 to an outlet, such as a chimney 914, a vent or the like. In FIG. 9, the system 900 also includes a bypass connection 908 between the input connection assembly 904 and the output connection assembly 906, which allows all or a portion of the exhaust gas from the carbon dioxide generating device to bypass the cartridges 902 and to be directly provided from the input assembly 904 to the output assembly 906. The flow of the exhaust gas to the cartridges 902 and/or through the bypass connection 908 is controlled by valves 910a-c, wherein the first valve 910a is disposed in the bypass connection 908, the second valve 910b is disposed in the input assembly 904 and the third valve 910c is disposed in the output assembly 906. In some embodiments, the exhaust flow is controlled to flow either through one or more cartridges 902 or through the bypass connection 908, while in other embodiments, the exhaust flow is controlled so that a portion of the exhaust is directed through the cartridges 902, while another portion of the exhaust is directed through the bypass connection 908. In such other embodiments, the amount of opening of the valves 910a-c is controlled so as to control the relative amounts of exhaust conveyed through the cartridges and bypassed around the cartridges.

The opening and closing of the valves 910a-c is controlled by a controller 912, which also controls other flow control devices (not shown) in the system 900 and monitors the absorbent capacity of the cartridges 902. As in the other embodiments described above, the controller 912 controls the flow of exhaust gas to the housing 903 and through one or more cartridges 902 based on measured or predicted absorption capacity of active cartridges. In some embodiments, one or more detectors (not shown) may be provided in the input assembly 904 for detecting the concentration of carbon dioxide in the exhaust gas prior to being conveyed through one or more cartridges 902 and/or in the output assembly 906 for detecting the concentration of carbon dioxide in the processed exhaust gas after being conveyed through one or more cartridges 902. In such embodiments, the controller 912 receives the signals from the one or more detectors and uses these signals to determine whether the absorbent in active cartridges have been spent and needs to be replaced. In other embodiments, the controller 912 monitors the amount of fuel used by the carbon dioxide generating device and/or the amount of exhaust output by the carbon dioxide generating device, and based on the amount of fuel used and/or the amount of exhaust output, determines when the absorbent in the active cartridge(s) needs replacement.

As in FIG. 8, if the controller 912 determines that the absorbent in the active cartridge(s) needs replacement, the controller outputs an alert signal to the user, and in some embodiments, also controls the flow of the exhaust gas to the cartridge(s) so as to redirect the flow of the exhaust gas to other unspent cartridge(s), or to other housings with unspent cartridge(s) by controlling appropriate flow control devices (not shown) if the system. In some embodiments, the controller 912 controls the flow of the exhaust gas from the carbon dioxide generating device 950 to the bypass connection 908 so as to bypass the cartridge(s), particularly when the controller 912 determines that the absorbent in all of the cartridges 902 in the system 900 has been used up and needs replacement.

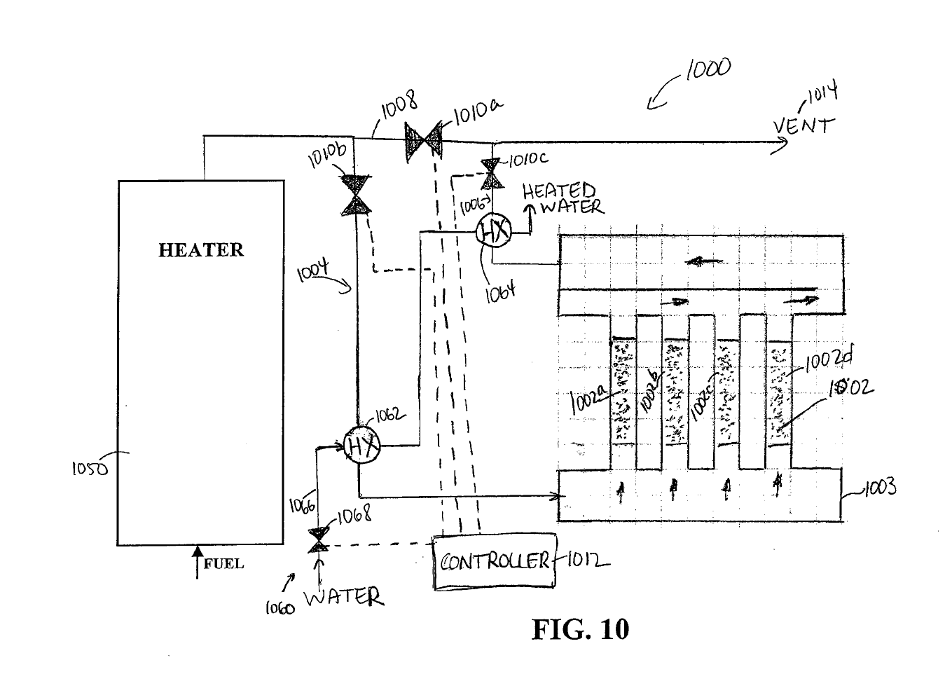

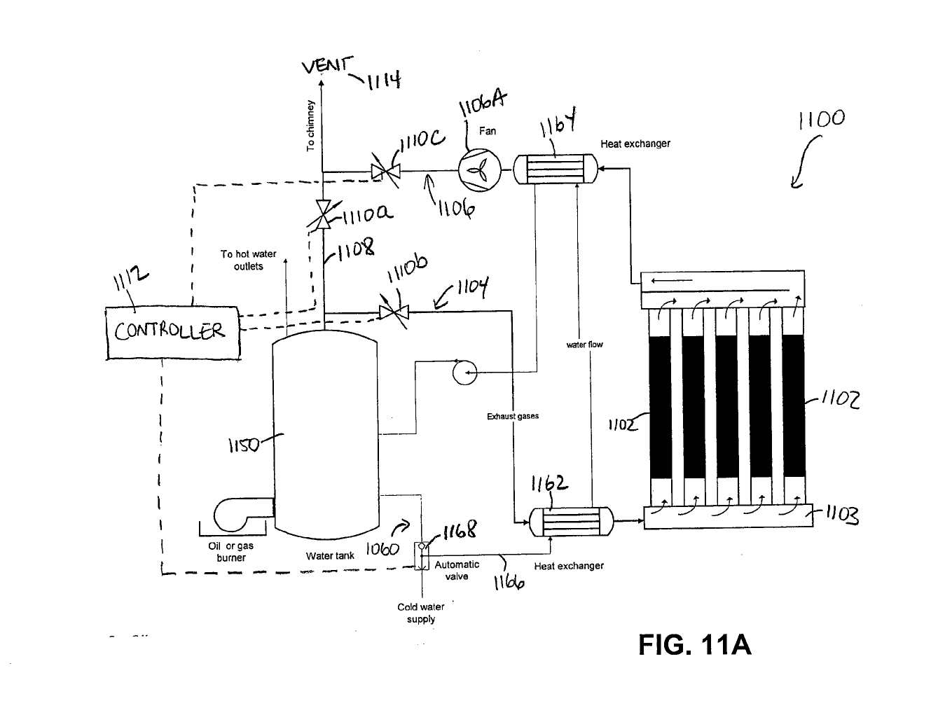

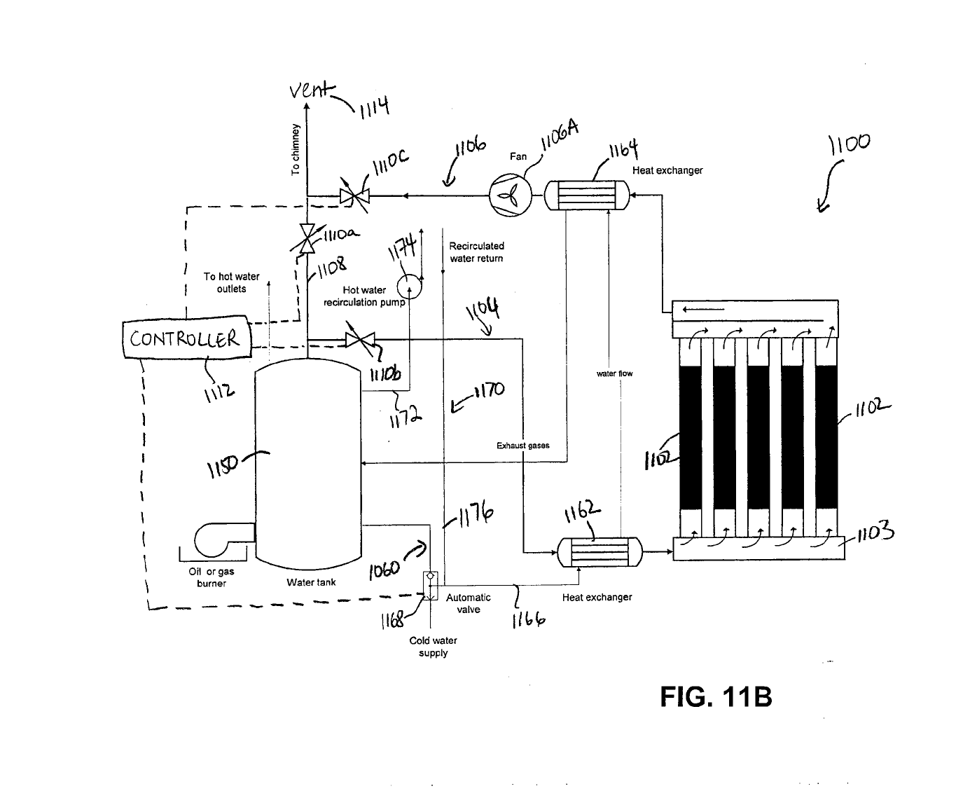

FIG. 10 shows a modified embodiment of the carbon dioxide removal system of FIG. 8 adapted for industrial or household use. As shown in FIG. 10, the carbon dioxide system 1000 has the same or similar construction to the system 800 of FIG. 8 and includes a heating assembly 1060 for heating water and/or other fluid. As shown in FIG. 10, the system 1000 comprises one or more absorption cartridges or containers 1002 housing therein a solid absorbent material for absorbing carbon dioxide, an input assembly 1004 connecting exhaust gas output from a carbon dioxide generating device 1050 with the cartridges 1002 and an output assembly 1006 connecting the cartridges with a vent for outputting processed exhaust gas. As in FIG. 8, the carbon dioxide generating device 1050 of FIG. 10 is a heater, such as a household oil or gas heater or furnace, an oil or gas water heater, or a water heating system. It is understood that other devices producing exhaust gas with carbon dioxide may be used as the device 1050 in FIG. 10. Also, as in FIG. 8, the absorbent may comprise one or more alkali hydroxides and/or alkali earth hydroxides, such as calcium hydroxide, sodium hydroxide, and potassium hydroxide. For example lime or soda lime is a suitable absorbent in granular form.

The arrangement of the cartridges 1002, the input assembly 1004, the output assembly 1006 and the carbon dioxide device 1050 in this embodiment is the same or substantially similar to the arrangement of these components in FIG. 8. Accordingly, detailed description thereof will be omitted.

As shown in FIG. 10, the heating assembly 1060 includes a first heat exchanger 1062, a second heat exchanger 1064 and a connecting line 1066 for conveying water or other liquid through the first and second heat exchangers. As shown in FIG. 10, the first heat exchanger is disposed in the input assembly 1004 and receives exhaust output from the heater 1050. The first heat exchanger 1062 also receives water and conveys the water in a heat exchange relationship with the heater exhaust so as to heat the water using the heat from the heater exhaust. In this way, the heater exhaust is cooled before being conveyed to a housing 1003 that houses the absorber cartridges 1002, which improves the speed of the absorption reaction between the absorber and the carbon dioxide in the exhaust. The heating assembly 1060 also includes a second heat exchanger 1064 disposed in the output assembly 1006 of the system 1000. The second heat exchanger 1064 receives the water heated by the first heat exchanger 1062 via a connecting line 1066 and processed exhaust output from the housing 1003, and conveys the water and the processed exhaust in a heat exchange relationship so as to further heat the water and to cool the processed exhaust. As mentioned above, the reaction between carbon dioxide in the exhaust and the absorber 1002 is exothermic, and thus the processed exhaust output from the housing is at a higher temperature than the exhaust input into the housing. As a result, the water is further heated in the second heat exchanger by the heat in the processed exhaust.

As shown in FIG. 10, the heating assembly 1060 further includes a flow control device 1068, such as one or more valves, for controlling the flow and/or the flow rate of water to the first and second heat exchangers 1062. The opening and closing of the flow control device 1068 is controlled by a controller 1012, which also controls flow control devices, or valves, 1010a-c in the input and output assemblies 1004, 1006 and in a bypass line 1008. In this way, the controller 1012 controls the flow of the exhaust to the absorber 1002, and/or through the bypass line 1008, and also controls the flow of water through the heating assembly 1060.

Although not shown in FIG. 10, the output assembly 1006 may also include a fan or a similar device downstream or upstream from the second heat exchanger. The fan or the like increases the speed of the processed exhaust so as to pump the processed exhaust out of the system and to facilitate movement of the exhaust through the system and thus, through the absorber cartridges. The operation of the fan or the like may be adjusted, and may be controlled by the controller 1012, so as that the flow of the exhaust through the absorber cartridges is at a predetermined speed or is maintained within a predetermined speed range.

The heated water output from the heating assembly 1060 can be used in the heater or in other devices. For example, in some illustrative embodiments the heater 1050 is a water heater or a water heating system, and all or a portion of the water supplied to the heater 1050 is first preheated using the heating assembly 1060, and thereafter, the heated water output from the heating assembly 1060 is supplied to the heater 1050 for further heating. In such embodiments, by preheating the water in the heating assembly 1060 the fuel requirements of the heater 1050 are reduced and the overall efficiency of the system 1000 is increased. For example, water supplied to the heating assembly 1060 at a temperature between about 50 and 60 degrees F. may be preheated to a temperature of about 80-90° F. by the heating assembly, thus reducing the fuel requirements of the water heater.

In other embodiments, the heated water output from the heating assembly 1060 is supplied to a different device from the heater, such as a water heater or a water heating system. For example, in some embodiments, the heater is a household heater, such as heating furnace, and the heated water is supplied from the heating assembly 1060 to a household water heater, or a water heating system, so as to increase the efficiency of the water heater or water heating system and its fuel requirements. Although not shown in FIG. 10, in such embodiments, the exhaust output from the water heater or water heating system may also be processed together with the exhaust output from the heater 1050 in the same carbon dioxide removal system 1000 by conveying the water heater/water heating system exhaust to the input assembly 1004 so as to combine the water heater/water heating system exhaust with the heater exhaust in the input assembly 1004. In this way, both the heater exhaust and the water heater/water heating system exhaust provide the heat needed for heating the water and are both processed to remove carbon dioxide therefrom by reacting with the absorber in the absorber cartridges 1002.

It is understood that the arrangements of the heater 1050 and the heating assembly 1060 may vary, and that the invention is not limited to providing the heated water to the heater 1050 or to a different water heater or water heating system. In particular, the heated water may be supplied to any device which heats water, or fluids, or receives and/or uses heated water or fluids.

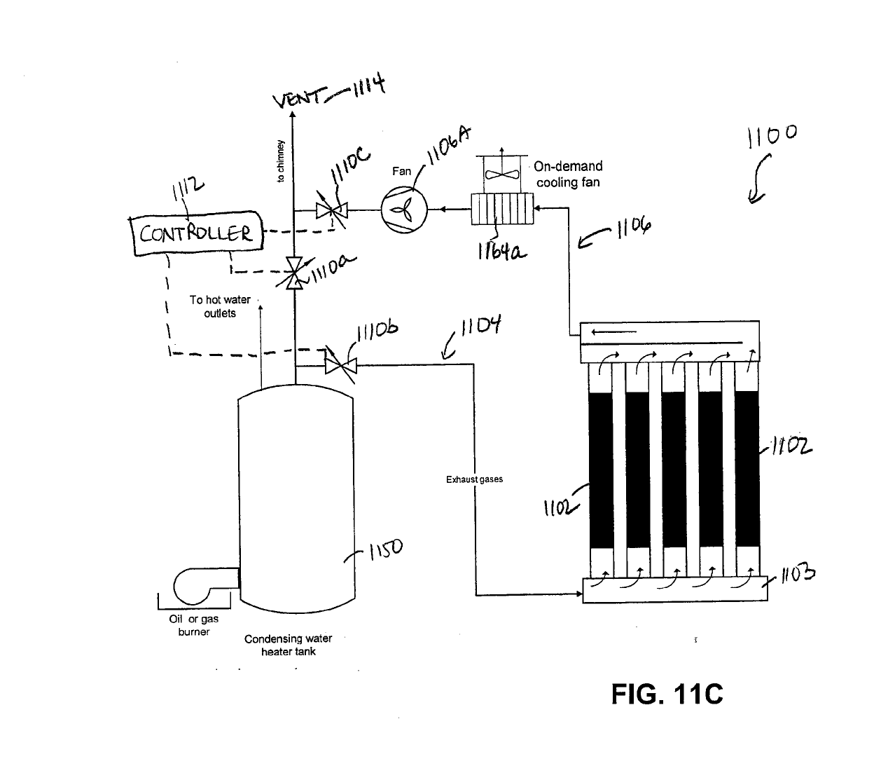

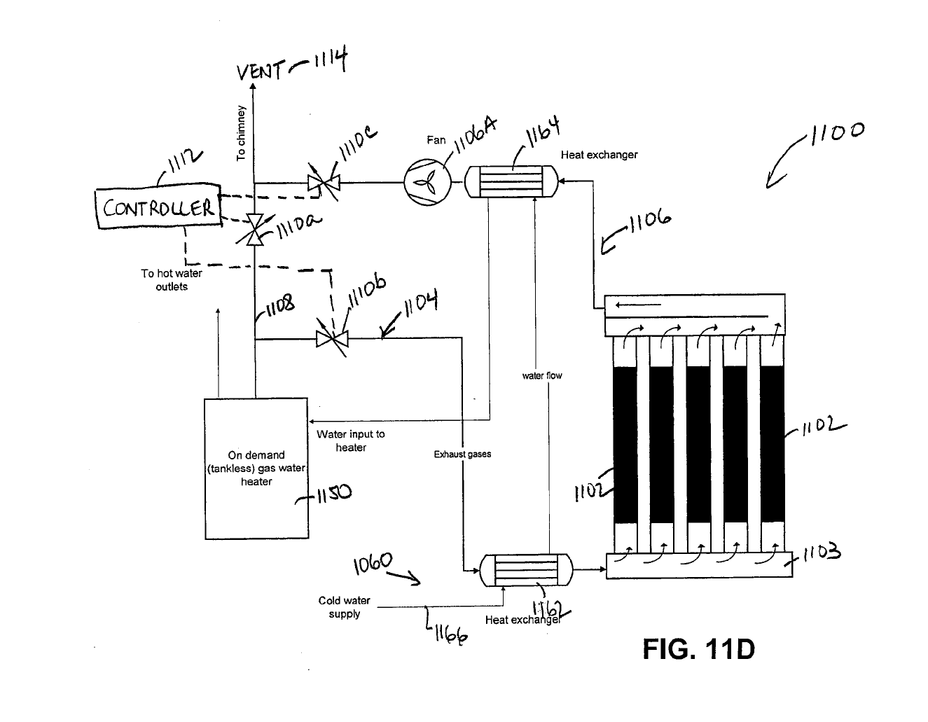

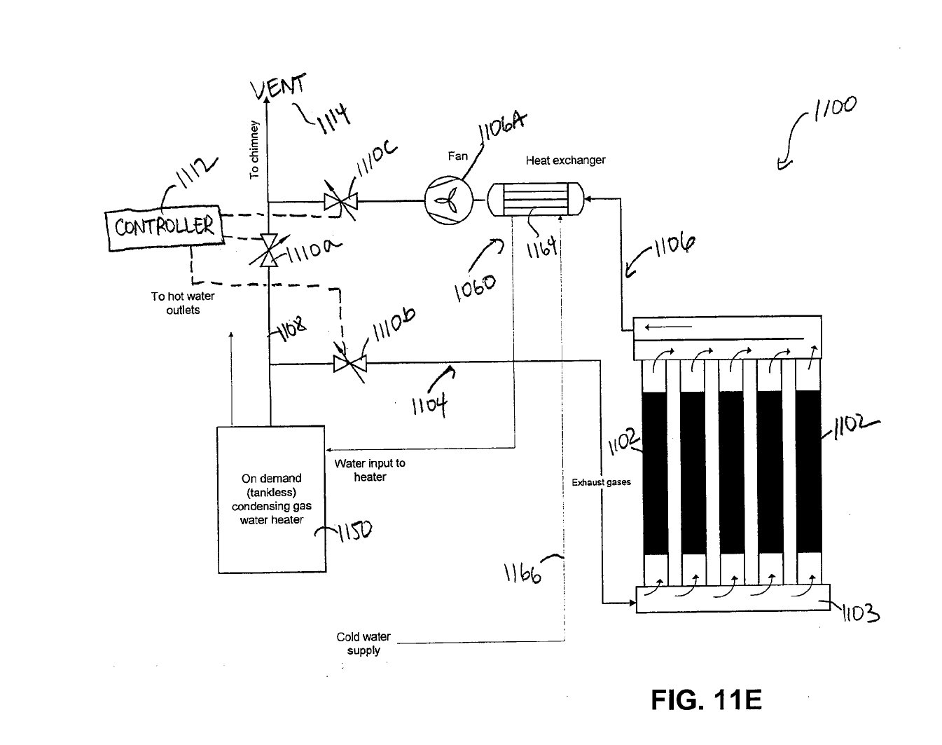

Other arrangements of the carbon dioxide removal system adapted for use with specific types of water heater systems are shown in FIGS. 11A-11E. In FIGS. 11A-11E, many of the components of the carbon dioxide removal system are the same or similar to those of the system shown in FIG. 10, and thus, similar reference numbers are used for those components. The water heater systems shown in FIGS. 11A-11E may operate on a variety of fuels, including, but not limited to oil, gas and the like.

FIGS. 11A and 11B show an arrangement of the carbon dioxide removal system 1100 adapted for use with oil or gas storage water heaters 1150 which include an automated switch 1168 between closed and open circuit cooling. The system 1100 of FIG. 11B is used with a storage water heater 1150 which also includes a hot water recirculation circuit for circulating hot water to the outside of the system, e.g., through pipes in the building, in order to provide hot water on demand. As in the system of FIG. 10, the systems of FIGS. 11A and 11B include one or more absorption cartridges or containers 1102 housing therein a solid absorbent material for absorbing carbon dioxide, an input assembly 1104 connecting exhaust gas output from the storage water heater 1150 with the cartridges 1102 and an output assembly 1106 connecting the cartridges with a vent or chimney 1114 for outputting processed exhaust gas. The arrangement of the cartridges 1102, the input assembly 1104, the output assembly and the water heater is substantially similar to the arrangement shown in FIG. 10, and thus, detailed description thereof will be omitted. In FIGS. 11A and 11B, a fan 1106A is provided in the output assembly 1106 for cooling the processed exhaust before it is output to the vent or chimney 1114 via a flow control valve 1110c in the output assembly 1106. As shown, a bypass line 1108 is provided for outputting the exhaust directly to the vent 1114 through a flow control valve 1110a, and the input assembly 1104 includes a flow control valve 1110b. The flow control valves 1110a and 1110b control the amount of exhaust conveyed to the cartridges 1102 and/or through the bypass line 1108, and the opening and closing of the flow control valves 1110a-1110c is controlled by a controller 1112.

As shown in FIGS. 11A and 11B, the water heater 1150 comprises a water tank storing water for heating by the water heater 1150. As in FIG. 10, the arrangement of FIGS. 11A and 11B includes a heating assembly 1160 for heating water stored in the water heater 1150 and includes a first heat exchanger 1162, provided in the input assembly 1104 and receiving exhaust output from the water heater 1150, and a second heat exchanger 1164 provided in the output assembly 1106 and receiving processed exhaust gas output from the cartridges 1102. Water from the water heater 1150 is provided through a flow control device 1168 and via a connecting line 1166 to the first heat exchanger 1162, where it is heated using exhaust gas from the water heater 1150, and thereafter, the heated water is conveyed to the second heat exchanger 1164 where it is further heated using the processed exhaust output from the cartridges 1102. As shown in FIGS. 11A and 11B, water further heated in the second heat exchanger 1164 is thereafter returned to the water heater, and as shown in FIG. 11A, a pump may be provided downstream from the second heat exchanger 1164 to pump the further heated water to the water heater 1150.

In FIGS. 11A and 11B, the flow control device 1168 is an automatic valve or an automated switch which controls the flow of the water from the water tank to the first heat exchanger 1162. The opening and closing of the flow control device 1168 is controlled by the controller 1112. In addition, the flow control device 1168 is coupled to an external cold water supply so as to enable supply of cold water from an external source to the first heat exchanger 1162. In this way, when the demand for hot water is greater, cold water from an external supply may be provided through the flow control device 1168 to the first heat exchanger 1162 for heating so as to provide an open circulation system and to achieve higher efficiency for the system. In addition, when the high demand for the hot water ceases, the flow control device 1168 may be controlled so that only water from the water heater 1150 is supplied to the first water heater 1162, thereby reverting to a closed circulation system.

The arrangement of FIG. 11B also includes a hot water recirculation circuit 1170 for circulating hot water to the outside of the water heater 1150, such as to circulate hot water through pipes in the building. As shown, the hot water recirculation circuit 1170 includes a recirculation input line 1172 through which hot water is pumped using a recirculation pump 1174 from the water heater and thereafter supplied to the outside of the water heater. The hot water recirculation circuit 1170 also includes a return line 1176 through which recirculated water is returned from the outside of the water heater to the input assembly 1104 of the heating assembly 1160. In the embodiment shown, the return line 1176 is coupled to the input assembly downstream from the flow control valve 1168 and upstream of the first heat exchanger 1162 so that returned recirculated water is heated in the first heat exchanger and thereafter in the second heat exchanger 1164 before being returned to the water heater. As mentioned above, the hot water recirculation circuit 1170 allows hot water to be provided immediately on demand to areas outside of the water heater, thus reducing water losses resulting from waiting for the hot water to be supplied.

FIG. 11C shows another arrangement in which the carbon dioxide removal system 1100 is used with a storage condensing water heater 1150. In the arrangement of FIG. 11C, the first heat exchanger is already built into the water heater 1150 and cools the gases to the condensation point or below. Therefore, in FIG. 11C, the first heat exchanger has been eliminated and the exhaust gas from the water heater 1150 is provided via the input assembly 1104 directly to the cartridges 1102. After passing through the absorber in the cartridges 1102, processed exhaust gas is conveyed to a fan-cooled heat exchanger 1164a which cools the processed exhaust. As in FIGS. 11A and 11B, a fan 1106A is provided downstream from the heat exchanger 1164a for further cooling the processed exhaust prior to outputting the processed exhaust to the vent 1114. The other components in FIG. 11C are substantially similar to those in the arrangement of FIGS. 11A and 11B, and thus, the description thereof is omitted.

FIGS. 11D and 11E show the carbon dioxide removal system 1100 being used with an on-demand or tankless water heater and with an on-demand or tankless condensing water heater. The arrangement of FIG. 11D is substantially similar to the arrangement in FIG. 11A, except the water supplied to the heating assembly 1160 is provided from an external cold water supply for heating by the first and second heat exchangers 1162 and 1164 since the water heater 1150 in FIG. 11D does not store water and instead provides hot water on demand. The other components in FIG. 11D are substantially similar to those in FIG. 11 and thus, the description thereof is omitted. Moreover, in FIG. 11E, the water supplied to the heating assembly 1160 is also provided from an external cold water supply and the first heat exchanger is omitted so that the cold water from the external supply is provided to the second heat exchanger 1164 directly. The remaining components in FIG. 11E are substantially similar to those of FIG. 11A, and a description thereof is therefore omitted.

As mentioned above and as shown in FIGS. 11A-11E, the valves 1110a-c, 1168 and other components are controlled by the controller 1112. The controller 1112 operates in a substantially similar fashion as the controller 1012 of FIG. 10 and as described herein above.

The carbon dioxide removal systems shown in FIGS. 8-11E can also be used as part of the business systems shown in FIGS. 5 and 6. In particular, in the household use of the carbon dioxide removal systems, the cartridge replacement services 406, 506 are used for removing spent absorber cartridges or spent absorber and replacing the spent cartridges or spent absorber with new cartridges or new absorber. In some embodiments, the cartridge replacement services 406, 506 may be provided as part of fuel supply services, wherein the supplier of the fuel for use in the household carbon dioxide generation device, e.g. household oil supplier, also removes spent cartridges/absorber and replaces them with new cartridges/new absorber. The supplier of the fuel 406, 506 can then receive carbon credits from the emissions agency 414, 514 corresponding to the amount of spent absorber collected by the fuel supplier or to the amount of carbon dioxide removed by the absorber. The fuel supplier 406, 506 may also sell its carbon credits to carbon credit buyers 412, 512 in the marketplace, and sell the spent absorber collected to a consumer or user of the spent absorber 416, 516 and/or to an intermediate seller or outlet 416a, 516a. Furthermore, the fuel supplier 406, 506 may provide the spent cartridges or spent absorber to a cartridge regeneration provider 408, 508 which regenerates the cartridges, returns the regenerated cartridges to the fuel supplier 406, 506 and/or provides compressed carbon dioxide to a carbon dioxide consumer or user 410, 510. In other embodiments, the cartridge replacement services may be provided by entities separate from the fuel supplier and/or the consumer may obtain replacement cartridges or absorber and dispose of spent cartridges or spent absorber at one or more cartridge replacement stations 404, 504.

In all cases it is understood that the above-described arrangements are merely illustrative of the many possible specific embodiments which represent applications of the present invention. Numerous and varied other arrangements can be readily devised in accordance with the principles of the present invention without departing from the spirit and scope of the present invention.

1. An exhaust processing assembly for an exhaust generating device, the exhaust processing assembly comprising:
one or more cartridges, each of the cartridges including a housing and a constituent housed in the housing and capable of at least partially removing carbon dioxide from the exhaust of the exhaust generating device, said constituent being one or more of a solid absorber and any other constituent;
wherein the cartridges are one of: (1) removable from the exhaust processing assembly and replaceable with other like cartridges, and (2) refillable with new constituent.

2. An exhaust processing assembly in accordance with claim 1, further comprising:
an input connection assembly for selectively coupling the exhaust produced by the exhaust generating device with the one or more cartridges; and
a control assembly for controlling the flow of the exhaust produced by the exhaust generating device through the input connection assembly to the one or more cartridges.

3. An exhaust processing assembly in accordance with claim 2, wherein the control assembly monitors carbon dioxide removing capacity of at least one cartridge while exhaust produced by the exhaust generating device is being conveyed through the at least one cartridge, based on one or more of: carbon dioxide concentration in processed exhaust output from the at least one cartridge detected using one or more carbon dioxide sensors, and fuel consumed by the exhaust generating device, and
wherein, if the control assembly determines that the carbon dioxide removing capacity of the one or more cartridges through which the exhaust is being conveyed is smaller than a predetermined value, the control assembly performs at least one of: displays an alarm to an operator of the exhaust generating device and controls to stop the flow of exhaust through the one or more cartridges and to convey the flow of exhaust through another one or more cartridges.

4. (canceled)

5. An exhaust processing assembly in accordance with claim 2, wherein:
the assembly comprises a plurality of cartridges including at least a first cartridge and a second cartridge connected with the exhaust produced by the exhaust generating device using the input connection assembly such that the exhaust is conveyed through one of the first cartridge and the second cartridge;
the control assembly monitors carbon dioxide removing capacity of at least one of the first cartridge and the second cartridge; and
the control assembly controls the flow of the exhaust through the input connection assembly such that:
(1) the exhaust is conveyed through the first cartridge while the second cartridge is in standby, and the control assembly monitors the carbon dioxide removing capacity of the first cartridge, and
(2) if the control assembly determines that the carbon dioxide removing capacity of the first cartridge is less than a predetermined value, then the control assembly controls the flow of exhaust through the input connection assembly such that no exhaust is conveyed through the first cartridge and the exhaust is conveyed through the second cartridge, and the control assembly monitors the carbon dioxide removing capacity of the second cartridge.

6. An exhaust processing assembly in accordance with claim 2, wherein:
the input connection assembly includes a plurality of flow control members corresponding to the one of more cartridges for controlling the flow of exhaust to the one or more cartridges;
the control assembly controls the opening and closing of the plurality of the flow control members so as to selectively control the flow of exhaust to the one or more cartridges; and
the exhaust processing assembly further comprises an output connection assembly for coupling the one or more cartridges with outside and outputting processed exhaust from the one or more cartridges to the outside.

7. (canceled)

8. An exhaust processing assembly in accordance with claim 2, wherein: the one or more cartridges are disposed in one or more chambers and the input connection assembly selectively couples the exhaust produced by the exhaust generating device with the one or more chambers, and
the assembly includes a plurality of chambers, including at least a first chamber and a second chamber;
each of the chambers houses a two or more cartridges connected in series;
the input connection assembly couples the exhaust produced by the exhaust generating device with the plurality of chambers such that the exhaust is conveyed through one of the first chamber and the second chamber; and
the control assembly controls the exhaust flow such that:
(1) the exhaust is conveyed to the first chamber while the second chamber is in standby and the control assembly monitors carbon dioxide removing capacity of the cartridges in the first chamber, and
(2) if the control assembly determines that the carbon dioxide removing capacity of the cartridges in the first chamber is less than a predetermined value, then the control assembly controls the exhaust flow such that no exhaust is conveyed to the first chamber and the exhaust is conveyed to the second chamber.

9. (canceled)

10. An exhaust processing assembly in accordance with claim 1, wherein one or more of:
(a) the constituent comprises a solid absorber, said solid absorber comprising one or more of: alkali hydroxide, alkali earth hydroxide, lime and soda lime; and
(b) the exhaust generating device is one of a vehicle, an industrial plant and a household heating device.

11. (canceled)

12. An exhaust processing assembly in accordance with claim 2, wherein:
the input connection assembly further comprises a bypass connecting line for coupling the exhaust output by the exhaust generating device with outside without conveying the exhaust through any of the cartridges; and
if the control assembly determines that the carbon dioxide removing capacity of the one or more cartridges through which the exhaust is being conveyed is smaller than a predetermined value, the control assembly performs at least one of: displays an alarm to an operator of the exhaust generating device, controls to stop the flow of exhaust to the one or more cartridges and to convey the flow of exhaust to another one or more cartridges, and controls to stop the flow of exhaust to the one or more cartridges and to convey the flow of exhaust to the bypass connecting line.

13. An exhaust processing assembly in accordance with claim 2, wherein the input connection assembly is adapted to evenly distribute the flow of exhaust to two or more cartridges and the input connection assembly comprises one or more of: (1) a plurality of connecting lines configured for even flow distribution to the two or more cartridges, (2) one or more baffles in one or more connecting lines for controlling the flow distribution and (3) one or more constrictions in one or more connecting lines for controlling the flow distribution.

14. A vehicle exhaust processing assembly comprising:
an intercooler adapted to receive exhaust produced by a vehicle and to cool the exhaust, while reducing engine noise of the vehicle; and
one or more cartridges including a constituent capable of at least partially removing carbon dioxide from the vehicle exhaust, said constituent being one or more of a solid absorber and any other constituent and the one or more cartridges being adapted to selectively receive cooled exhaust from the intercooler and to output processed exhaust.

15. A vehicle exhaust processing assembly in accordance with claim 14, further comprising:
an input connection assembly for selectively coupling the cooled exhaust from the intercooler to the one or more cartridges; and
a control assembly for controlling the flow of cooled exhaust through the input connection assembly and for monitoring the status of the one or more cartridges through which the exhaust is being conveyed.

16. A vehicle exhaust processing assembly in accordance with claim 15, wherein the control assembly monitors carbon dioxide removing capacity of at least one cartridge while exhaust is being conveyed through the at least one cartridge, based on one or more of: carbon dioxide concentration in processed exhaust output from the at least one cartridge detected using one or more carbon dioxide sensors, distance traveled by the vehicle and fuel consumed by the vehicle; and
wherein, if the control assembly determines that the carbon dioxide removing capacity of the one or more cartridges through which the exhaust is being conveyed is smaller than a predetermined value, the control assembly performs at least one of: displays an alarm to an operator of the vehicle and controls to stop the flow of exhaust through the one or more cartridges and to convey the flow of exhaust through another one or more cartridges.

17. (canceled)

18. A vehicle exhaust processing assembly in accordance with claim 15, wherein:
the assembly comprises a plurality of cartridges including at least a first cartridge and a second cartridge connected with the exhaust using the input connection assembly such that the exhaust is conveyed through one of the first cartridge and the second cartridge;
the control assembly monitors carbon dioxide removing capacity of at least one of the first cartridge and the second cartridge; and
the control assembly controls the flow of the exhaust through the input connection assembly such that:
(1) the exhaust is conveyed through the first cartridge while the second cartridge is in standby, and the control assembly monitors the carbon dioxide removing capacity of the first cartridge; and
if the control assembly determines that the carbon dioxide removing capacity of the first cartridge is less than a predetermined value, then the control assembly controls the flow of exhaust through the input connection assembly such that no exhaust is conveyed through the first cartridge and the exhaust is conveyed through the second cartridge and the control assembly monitors the carbon dioxide removing capacity of the second cartridge.

19. A vehicle exhaust processing assembly in accordance with claim 15, wherein:
the input connection assembly includes a plurality of flow control members corresponding to the one or more cartridges for controlling the flow of exhaust to the plurality of cartridges, including at least a first flow control member for controlling the flow of exhaust to the first cartridge and a second flow control member for controlling the flow of exhaust to the second cartridge;
the control assembly controls the opening and closing of the plurality of flow control members so as to selectively control the flow of exhaust to the plurality of cartridges.

20. A vehicle exhaust processing assembly in accordance with claim 15, wherein the one or more cartridges are disposed in one or more chambers and the input connection assembly selectively couples the exhaust from the intercooler with one or more chambers.

21. A vehicle exhaust processing assembly in accordance with claim 14, wherein one or more of:
(a) the vehicle exhaust processing assembly further comprises a cooling unit for further cooling the cooled exhaust output from the intercooler;
(b) the constituent comprises a solid absorber comprising one or more of: alkali hydroxide, alkali earth hydroxide, lime and soda lime; and
(c) the cartridges are one of: (1) removable from the vehicle exhaust processing assembly and replaceable with other like cartridges, and (2) refillable with new constituent.

22. (canceled)

23. (canceled)

24. (canceled)

25. A vehicle comprising the exhaust processing assembly of claim 1, wherein one or more of: the cartridges are sized according to the size of the vehicle and the cartridges are housed in a body of the vehicle.

26. (canceled)

27. A vehicle comprising a chassis, a body and the exhaust processing assembly in accordance with claim 2, wherein:
the body includes a passenger compartment and a storage compartment,
the cartridges are housed in the storage compartment of the body and are accessible through the storage compartment for one of: removal and replacement, and refilling of the constituent; and
the number of cartridges is based on at least dimensions of the storage compartment.

28. A vehicle in accordance with claim 27, further comprising a vehicle controller for controlling the operations of the vehicle and an output connection assembly for coupling the cartridges with outside and outputting processed exhaust from one or more cartridges to the outside, the output connection assembly including a tailpipe of the vehicle, and wherein:
at least a portion of the input connection assembly is disposed outside of the vehicle body and is connected to the chassis of the vehicle; and
the control assembly of the vehicle exhaust processing assembly is one of: (1) a part of the vehicle controller and (2) separate from the vehicle controller and adapted to communicate with the vehicle controller.

29. (canceled)

30. A vehicle comprising a chassis, a body and the exhaust processing assembly in accordance with claim 15, wherein the intercooler of the exhaust processing assembly is disposed under the chassis or in a lower part of the chassis and replaces at least one of a muffler and a resonator of the vehicle.

31. A vehicle in accordance with claim 30, wherein:
the body includes a passenger compartment and a storage compartment,
the cartridges are housed in the storage compartment of the body and are accessible through the storage compartment for one of: removal and replacement, and refilling of the constituent; and
the number of cartridges is based on at least dimensions of the storage compartment.

32. A vehicle in accordance with claim 31, wherein:
the vehicle comprises a vehicle controller for controlling the operations of the vehicle;
at least a portion of the input connection assembly is disposed outside of the vehicle body and is connected to the chassis of the vehicle; and
the control assembly of the vehicle exhaust processing assembly is one of: (1) a part of the vehicle controller and (2) separate from the vehicle controller and adapted to communicate with the vehicle controller.

33. A vehicle in accordance with claim 30, said vehicle further comprising a catalytic converter, wherein the intercooler receives the exhaust output from the catalytic converter.

34. A method of removing carbon dioxide from an exhaust produced by an exhaust generating device comprising the steps of:
providing one or more cartridges, each of said cartridges including a constituent for at least partially removing carbon dioxide from the exhaust, said constituent being one or more of a solid absorber and any other constituent, and each of said cartridges being one of replaceable with a like cartridge and refillable with new constituent;
conveying exhaust gas from the exhaust generating device to at least one of the cartridges; and
outputting processed exhaust from the at least one of the cartridges.

35. A method in accordance with claim 34, further comprising one of:
removing and replacing the at least one of the cartridges after occurrence of a predetermined condition; and
removing constituent from the at least one of the cartridges and refilling the at least one of the cartridges with new after occurrence of the predetermined condition.

36. A method in accordance with claim 35, further comprising monitoring carbon dioxide removing capacity of the at least one of the cartridges and determining whether the carbon dioxide removing capacity of the at least one of the cartridges is less than a predetermined value,
wherein the predetermined condition occurs if it is determined that the carbon dioxide removing capacity of the at least one of the cartridges is less than a predetermined value.

37. A method in accordance with claim 36, further comprising, upon occurrence of the predetermined condition, one or more of:
controlling the flow of exhaust so as to stop the flow of the exhaust to the at least one of the cartridges and to convey the exhaust to at least one other cartridge; and
displaying an alarm to a user.

38. A method in accordance with claim 36, wherein:
said step of providing one or more cartridges comprises providing a plurality of cartridges;
said step of conveying exhaust gas comprises conveying the exhaust gas to at least one of the plurality of cartridges; and
upon occurrence of the predetermined condition, determining whether any other cartridge of the plurality of cartridges is in standby; and
if it is determined that at least one other cartridge is in standby, changing the flow of exhaust from the at least one of the cartridges to at least one other cartridge in standby and displaying an alarm to a user; and
if it is determined that no other cartridge is in standby, one or more of displaying an alarm to a user and changing the flow of exhaust to be conveyed to a bypass line bypassing said plurality of cartridges.

39. (canceled)

40. A cartridge for use in an exhaust processing assembly of claim 1, the cartridge comprising:
a housing having a lower end and an upper end; and
a constituent housed in the housing and capable of at least partially removing carbon dioxide from the exhaust generating device exhaust, said constituent being one or more of a solid absorber and any other constituent;
wherein the housing is configured to be releasably coupled with an exhaust system of the exhaust generating device so that exhaust produced by the exhaust system is conveyed through the housing from the lower end of the housing to the upper end of the housing; and
the cartridge is at least one of replaceable with another like cartridge and re-fillable with new constituent.

41. The cartridge in accordance with claim 40, wherein one or more of:
(a) the constituent is a solid absorber and comprises one or more of an alkali hydroxide absorber, an alkali earth hydroxide, lime and soda lime;
(b) the constituent is a granular solid absorber and comprises granules between 3 and 4 mm in diameter; and
(c) the housing includes one or more baffles for directing and distributing the flow of the exhaust through the housing.

42. (canceled)

43. (canceled)

44. A business system for removal of carbon dioxide from exhaust produced by one or more carbon dioxide generation devices, wherein one or more exhaust processing assemblies are installed in one or more carbon dioxide generation devices, each of the exhaust processing assemblies comprising one or more cartridges, each of the cartridges housing a constituent capable of at least partially removing carbon dioxide from the exhaust and being one or more of a solid absorber and any other constituent, the system comprising one or more of:
one or more cartridge replacement stations providing replacement cartridges for use in the one or more exhaust processing assemblies and collecting spent cartridges removed from exhaust processing assemblies;
one or more constituent replacement stations collecting spent constituent from spent cartridges from one or more exhaust processing assemblies and providing at least one of replacement cartridges and replacement constituent for use in the one or more exhaust processing assemblies;
one or more constituent regeneration providers receiving one or more of spent cartridges and spent constituent, regenerating at least a portion of said spent constituent and providing at least one of regenerated cartridges and regenerated constituent for use in the one or more exhaust processing assemblies; and
one or more spent constituent providers receiving one or more of spent cartridges and spent constituent, and providing a spent constituent product to one or more users of said spent constituent directly or indirectly through one or more sellers, wherein the spent constituent product comprises one or more of spent constituent and material derived from said spent constituent.

45. (canceled)

46. A business system in accordance with claim 44, wherein one or more of:
(a) the one or more constituent regeneration providers produce compressed carbon dioxide from regenerating the spent constituent and provide compressed carbon dioxide to consumers;
(b) an emissions monitoring agency provides credits proportional to the amount of carbon dioxide removed by the cartridges from the exhaust, said credits being saleable to other entities, and one or more of the operators of carbon dioxide generation devices, cartridge replacement stations, constituent replacement stations, constituent regeneration providers and spent constituent providers receive said credits from the emissions monitoring assembly;
(c) an emissions monitoring agency provides credits proportional to the amount of carbon dioxide removed by the cartridges from the exhaust, said credits being saleable to other entities, and one or more of the cartridge replacement stations and constituent replacement stations receive said credits from the emissions monitoring assembly and provide discounts or incentives to operators of carbon dioxide generation devices in exchange for spent cartridges;
(d) the carbon dioxide generation devices include one or more of vehicles, household heating devices and industrial plants;
(e) said constituent comprises a solid hydroxide and said spent constituent product comprises one of a solid carbonate and a material derived from solid carbonate;
(f) said constituent comprises calcium hydroxide and said spent constituent product comprises calcium carbonate;
(e) the system comprises one or more spent constituent providers and said one or more users of the spent constituent product use the spent constituent product for one or more of: production of quicklime, production of slaked lime, production of cement, removing iron from iron ore in blast furnaces, combining with impurities to form slag during smelting and refining processes, reaction with sulfur dioxide during desulfurization processes, glass making, for acid neutralization, inclusion as a filler in paper paint, rubber and plastics, filtration as a filter stone in sewage treatment systems, production of roofing materials, providing calcium in lifestock after purification, road construction as an aggregate, providing mine safety dust, manufacture of building materials and manufacture of sheetrock-type materials.

47-54. (canceled)

55. A method of removing carbon dioxide from one or more carbon dioxide generation devices, each of said carbon dioxide generation devices outputting exhaust to an exhaust processing assembly in accordance with claim 1, the method comprising:
using the exhaust processing assembly to remove carbon dioxide from the exhaust of the carbon dioxide generation device; and
one of:
(a) replacing one or more spent cartridges in the exhaust processing assembly with one or more replacement cartridges; and
(b) replacing constituent in one or more spent cartridges in the exhaust processing assembly with new constituent.

56. A method accordance with claim 55, wherein the carbon dioxide generation devices include one or more of: vehicles, household heating devices and industrial plants and wherein the method further comprises:
obtaining credits, wherein the credits provided are proportional to the amount of carbon dioxide removed by the cartridges from exhaust and the credits may be sold to other entities.

57. (canceled)

58. A method of removing carbon dioxide from one or more carbon dioxide generation devices, each of said carbon dioxide generation devices output exhaust to an exhaust processing assembly in accordance with claim 1 for removing carbon dioxide from the exhaust, the method comprising:
collecting at least one of spent cartridges and spent constituent from the exhaust processing assemblies; and
providing at least one of replacement cartridges and replacement constituent for use in the one or more exhaust processing assemblies in place of the spent cartridges or spent constituent.

59. A method in accordance with claim 58, further comprising one or more of:
(a) providing at least one of spent cartridges and spent constituent to one or more constituent regeneration providers and receiving at least one of regenerated cartridges and regenerated constituent from the one or more constituent regeneration providers;
(b) receiving credits, wherein said credits are proportional to the amount of carbon dioxide removed by the cartridges from exhaust and the credits may be sold to other entities; and
(c) providing discounts or incentives to operators of carbon dioxide generation devices in exchange for at least one of spent cartridges and spent constituent.

60. (canceled)

61. A method of removing carbon dioxide from one or more carbon dioxide generation devices, each of said carbon dioxide generation devices output exhaust to an exhaust processing assembly in accordance with claim 1 for removing carbon dioxide from exhaust, the method comprising:
collecting spent constituent from the exhaust processing assemblies; and
providing a spent constituent product to one or more users of said spent constituents;
wherein said spent constituent product comprises one or more of spent constituent and material derived from said spent constituent.

62. A method of utilizing constituent produced by removal of carbon dioxide from one or more carbon dioxide generation devices, each of the carbon dioxide generation devices outputting exhaust to an exhaust processing assembly in accordance with claim 1 for removing carbon dioxide from the exhaust, wherein at least one of spent cartridges and spent constituent from one or more exhaust processing assemblies is collected, said method comprising:
obtaining spent constituent collected from at least one of the spent cartridges and from the one or more exhaust processing assemblies, and
using the spent constituent for one or more of: production of quicklime, production of slaked lime, production of cement, removing iron from iron ore in blast furnaces, combining with impurities to form slag during smelting and refining processes, reaction with sulfur dioxide during desulfurization processes, glass making, for acid neutralization, inclusion as a filler in paper paint, rubber and plastics, filtration as a filter stone in sewage treatment systems, production of roofing materials, providing calcium in lifestock after purification, road construction as an aggregate, providing mine safety dust, manufacture of building materials and manufacture of sheetrock-type materials.

63. (canceled)

64. A method of utilizing carbon dioxide from one or more carbon dioxide generation devices, each of said carbon dioxide generation devices outputting exhaust to an exhaust processing assembly in accordance with claim 1 for removing carbon dioxide from the exhaust, wherein at least one of spent cartridges and spent constituent from the carbon dioxide generation devices is collected from one or more exhaust processing assemblies, the method comprising:
obtaining said at least one of spent cartridges and spent constituent collected from the one or more exhaust processing assemblies;
regenerating said at least one of spent cartridges and spent constituent obtained in the obtaining step;
producing compressed carbon dioxide as a result of regenerating in the regenerating step;
providing at least one of regenerated cartridges and regenerated constituent for use in one or more exhaust processing assemblies; and
providing compressed carbon dioxide to carbon dioxide consumers.

65. (canceled)

66. (canceled)

67. A method in accordance with claim 64, further comprising:
receiving credits,
wherein said credits provided are proportional to the amount of carbon dioxide removed by the cartridges from exhaust and the credits may be sold to other entities.

68. An exhaust processing assembly in accordance with claim 2, wherein:
the carbon dioxide generating device is a vehicle; and
the control assembly monitors carbon dioxide removing capacity of at least one cartridge while exhaust produced by the carbon dioxide generating device is being conveyed through the at least one cartridge, based on one or more of: carbon dioxide concentration in processed exhaust output from the at least one cartridge, distance traveled by the vehicle and fuel consumed by the vehicle.

69. (canceled)

70. An exhaust processing assembly in accordance with claim 1, wherein:
the exhaust generating device is a household heating device;
the exhaust processing assembly further includes a heating assembly for heating water using at least one of (a) the exhaust of the exhaust generating device and (b) processed exhaust output from the one or more cartridges.

71. An exhaust processing assembly in accordance with claim 70, wherein:
the exhaust generating device is one of a water heater and a water heating system; and
all or a portion of the water heated by the heating assembly is provided to the exhaust generating device for further heating.
